(19) United States
(12) Patent Application Publication
(10) Pub. No.: US 2025/0199610 A1
(43) Pub. Date: Jun. 19, 2025

(54) METHOD, SYSTEM, AND TECHNIQUES FOR VARYING EYE GAZE DWELL ACTIVATION TIMING

(71) Applicant: Jay Curtis Beavers, Duvall, WA (US)

(72) Inventor: Jay Curtis Beavers, Duvall, WA (US)

(21) Appl. No.: 18/904,596

(22) Filed: Oct. 2, 2024

Related U.S. Application Data
(60) Provisional application No. 63/611,912, filed on Dec. 19, 2023.

(51) Int. Cl. G06F 3/01; G06F 3/04845; G06F 3/04886

(52) U.S. Cl. CPC G06F 3/013; G06F 3/04845; G06F 3/04886; G06F 2203/04803

(57) ABSTRACT

Methods, systems, and techniques for controlling visual elements or other device interfaces using eye gaze dwell where the time of the fixation required to perform the actuation (i.e., the duration of the dwell) may vary are provided. Example embodiments provide an Eye Gaze Dwell Activation System “EGDAS”, which determines based upon one or more characteristics how to vary dwell time for different user interface elements in a user interface and enables users to respond to and potentially manage different dwell length (i.e., timing) for different aspects/objects being controlled. In one embodiment, the EGDAS uses characteristics and/or models that relate actions to one or more of probability of occurrence (or frequency), context, consequence and/or proximity. In some EGDAS implementations, these variable dwell times may change further while the user interface/device is being controlled.

### CROSS-REFERENCE TO RELATED APPLICATIONS

This application claims priority to U.S. Provisional Patent Application No. 63/611,912, titled “METHOD, SYSTEM, AND TECHNIQUES FOR VARYING EYE GAZE DWELL ACTIVATION,” filed Dec. 19, 2023; which application is incorporated herein by reference in their entireties.

### TECHNICAL FIELD

The present disclosure relates to methods, techniques, and systems for actuating visual elements using eye gaze dwell and, in particular, to methods, techniques, and systems for varying eye gaze dwell activation timing.

### BACKGROUND

Eye gaze systems enable people to control computers and other devices without using their hands. Some established example uses are to provide an alternative computer input system instead of a mouse, keyboard, or joystick for people living with motor neuron disabilities, providing an input system for virtual or augmented reality systems, for typing on a virtual keyboard to generate synthetic speech for someone who cannot use their voice, and/or for providing an enhanced gaming experience by changing the view of the simulation based on the direction the player is looking.

The current state of the computer assistive industry uses dwell timings for the actuation of these visual elements that are fixed system wide. For example, Apple's Assistive Touch Dwell Control allows a person to select a length of activation delay from 2.0 to 0.25 seconds, but every actionable visual element shares the same activation delay to determine whether to actuate (i.e., activate, select, or the like) a visual element. Tobii Dynavox's TD Control (see “https://www.tobiidynavox.com/products/td-control) similarly selects one system-wide activation delay to determine whether a person intends to use their gaze for actuation.

Visualization of the passage of time of the delay as the person holds their gaze (e.g., dwells) on the element before activation is sometimes presented using several different methods and styles to increase feedback to the person using an eye-gaze assisted system. These can vary from an initial color or visibility change to the background or border of the visual element changing; a variation of the text, such as bolding or resizing the letter(s) or glyph(s); or an animation, such as a shrinking focus circle or a sweeping arc reminiscent of the hand of a clock.

### BRIEF DESCRIPTION OF THE DRAWINGS

FIG. 1 is a screen display of the Apple iPadOS Assistive Touch Eye Gaze Device settings display screen.

FIG. 2 is a screen display of the Tobii Dynavox Eye Tracking settings display screen.

FIG. 3 is an example block diagram of an English QWERTY keyboard with several different styles of dwell delay activation states visualized.

FIG. 4A illustrates an analysis of letter frequency probability based on the words contained in the Oxford English Dictionary.

FIG. 4B is an example block diagram of an English QWERTY keyboard with the statistical probability of each letter visible under each key.

FIG. 5A is an example block diagram of variable dwell times provided by an example EGDAS configured to incorporate variable dwell times using key probability.

FIG. 5B is an example block diagram of variable dwell times provided by an example EGDAS configured to incorporate variable dwell times using context for an English QWERTY keyboard interface.

FIG. 5C is another example block diagram of variable dwell times provided by an example EGDAS configured to incorporate variable dwell times using context for an English QWERTY keyboard interface.

FIG. 6A is an example user interface for a soccer simulation game with movement keys and action buttons that can be controlled by an example EGDAS configured to incorporate variable dwell times based upon consequence.

FIG. 6B is an example user interface for an example aircraft control system with movement keys and action buttons that can be controlled by an example EGDAS configured to incorporate variable dwell times based upon consequence.

FIGS. 7A and 7B are an example user interface for a virtual adventure game with movement keys and an action bar that can be controlled by an example EGDAS configured to incorporate variable dwell times based upon consequence, probability, and/or proximity.

FIG. 8A is an example block diagram of a room filled with example automation controllable devices.

FIG. 8B is an example block diagram of an example user interface using buttons to control automation devices in a location by an example EGDAS configured to incorporate variable dwell times based upon context, probability, proximity or other factors.

FIG. 8C is a visualization showing multiple graphs that illustrate a mathematical relationship of dwell time to a user's distance or proximity to a device being actuated.

FIG. 9 is an overview flow diagram of the logical behavior of an example Eye Gaze Dwell Activation System.

FIG. 10 is an example block diagram of a computing system for practicing embodiments of an Eye Gaze Dwell Activation System.

FIG. 11A is an example block diagram of components of a vehicle or drone system that deploys an example Eye Gaze Dwell Activation System for operating the vehicle or drone.

FIG. 11B is an example block diagram of components of a virtual keyboard that deploys an example Eye Gaze Dwell Activation System for controlling the virtual keyboard.

FIG. 11C is an example block diagram of components of a home automation system that deploys an example Eye Gaze Dwell Activation System for operating the home automation system.

FIG. 12 is an example flow diagram for determining activation delay in an example Eye Gaze Dwell Activation System for operating a vehicle or drone.

FIG. 13 is an example flow diagram for determining activation delay in an example Eye Gaze Dwell Activation System for a virtual keyboard used to generate text.

FIG. 14 is an example flow diagram for determining activation delay in an example Eye Gaze Dwell Activation System for operating a home automation system.

FIG. 15 illustrates example environments that include an eye gaze camera and display systems in powered beds and wheelchairs for practicing an example Eye Gaze Dwell Activation System.

FIG. 16 is an example environment that includes an eye gaze camera and display system in a headset used for virtual or augmented reality for practicing an example Eye Gaze Dwell Activation System.

FIG. 17 is an example block diagram of an augmented reality system for practicing an example Eye Gaze Dwell Activation System.

### DETAILED DESCRIPTION

Embodiments described herein provide enhanced computer-, processor- and network-based methods, techniques, and systems for controlling visual elements or other device interfaces using eye gaze dwell where the time of the fixation required to perform the actuation (i.e., the duration of the dwell) may vary. Example embodiments provide a an Eye Gaze Dwell Activation System (“EGDAS”), which enables users to use different dwell length (i.e., timing) for different aspects/objects being controlled, for example, based upon probability, context, consequence, and/or proximity. In overview, an EGDAS consists of an eye gaze enabled display device with a computing processor running an application that responds to gaze on visual elements to take various actions, either on the device itself in the case of controlling a computer simulation, with an application, or within the physical world such as using a vehicle driving interface or home automation system.

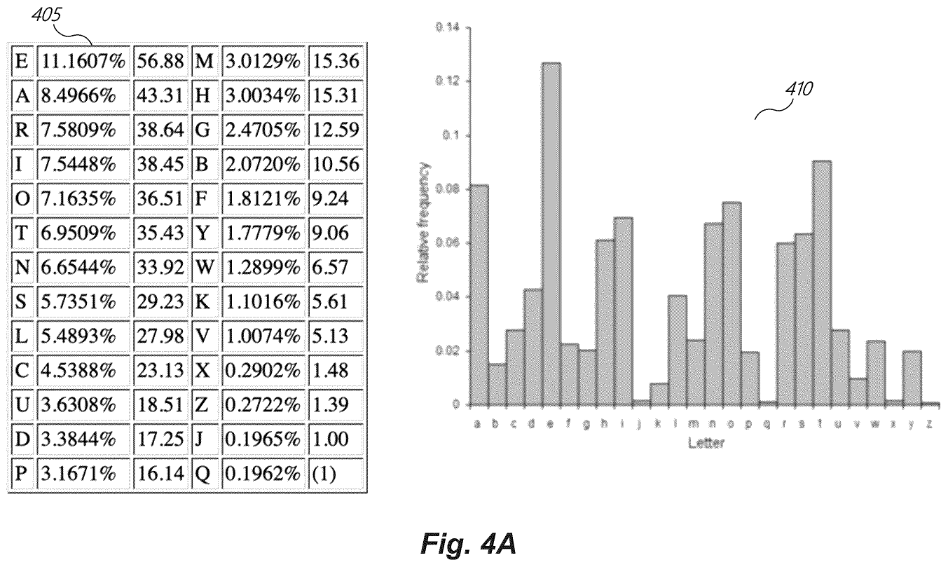

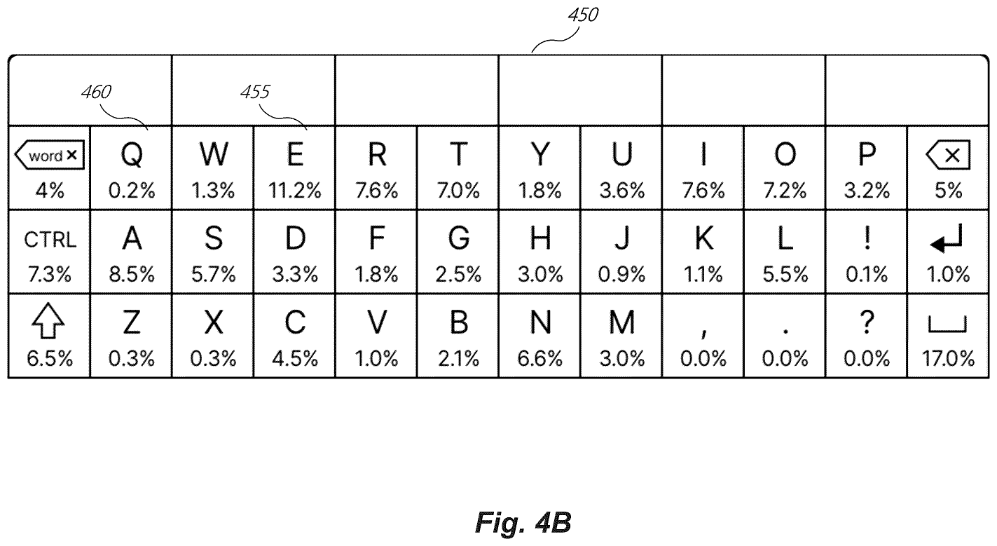

For example, when an EGDAS is used to control IoT device interfaces, the EGDAS may implement different dwell timing for different object/devices. Similarly, when an EGDAS is used to generate speech, the EGDAS may use different and/or variable dwell lengths for the different keys on a keyboard based upon their frequency of occurrence in the language of interest. In addition, these variable dwell times may change further while the user interface/device is being controlled. In these instances the EGDAS may be, for example, implemented as code logic resident in a set of virtual or augmented reality glasses such as Google Glass or Apple Vision Pro, or firmware embedded in a vehicle control system, or on a computer display with attached or integrated eye gaze sensors, and the like. Examples of such interfaces are described below with respect to FIGS. 4A-8B.

When eye gaze data is received, it can be used to take an action (e.g., click a button, select a device to control, and the like) using a technique called “Dwell” or “Fixation Duration.” This technique uses a length of time that the person focuses on an action area, like a virtual button on a computer screen, and a timer which measures the passage (duration) of a period of continuous focus time. In some scenarios, the timer may be presented visually to the user to increase feedback and thus precision.

Before being used to actuate (or present, and/or control) something, the eye gaze data may be modified depending upon the implementation or deployment. For example, in some implementations, the eye gaze data is modified using a data filter to provide a better experience in the presence of random or systemic error. In some implementations, the eye gaze data is combined with knowledge of the location of action areas so that the eye gaze data is ‘bent’ or ‘attracted to’ potential areas of focus or an action in a vision area, similar in mathematical behavior to how gravitational masses attract other bodies of mass.

Regardless of how or whether the eye gaze data is modified or filtered, this data stream is then used to determine the amount (duration or length of time) of attention or fixation that has been given to an action area. For purposes of ease, this description often refers to examples of controlling an action or visual area. It is to be understood that “action area” or “visual area” may refer to an entire device, a portion of a device, and/or a user interface of any kind imaginable, providing the area is defined or definable in order to be understood by the EGDAS.

The minimum or threshold time that needs to elapse before the gaze attention/fixation on an action area is determined to represent the person's intent is referred to as an “activation boundary.” Once an activation boundary has passed, the action associated with the action area is taken. One example of this is to simulate a ‘button click’ as if it was activated by a mouse click or a finger touch when the EGDAS determines that an activation boundary associated with a button in a user interface has passed. In many cases, this activation boundary is represented as a simple time span known also as a Gaze Delay, Dwell Time, or Gaze Duration. In some implementations, the gaze

In some cases, rather than using a timer to measures gaze length/duration on an object, the activation boundary may be determined (and even represented or presented) as “accumulated heat” using a technique known as ‘heat mapping’ in which an instantaneous gaze point over an action area ‘adds heat’, and, when the gaze point leaves the attention area, the heat slowly “cools off”. This type of determination allows a person's gaze to wander off the attention area briefly while allowing it to return and resume increasing the ‘heat’ towards the activation boundary. Irrespective to the method of determining whether the activation boundary has been passed (a simple gaze duration timer, a modified gaze data stream (filtered or attracted), or a heat accumulation technique), the technique of varying an activation boundary based on probability, context, consequence, or proximity can be applied by an EGDAS.

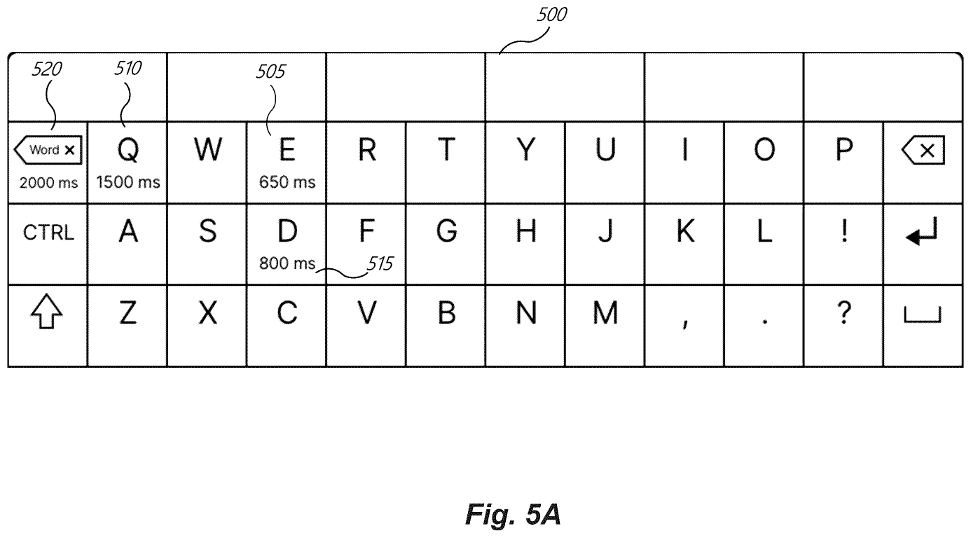

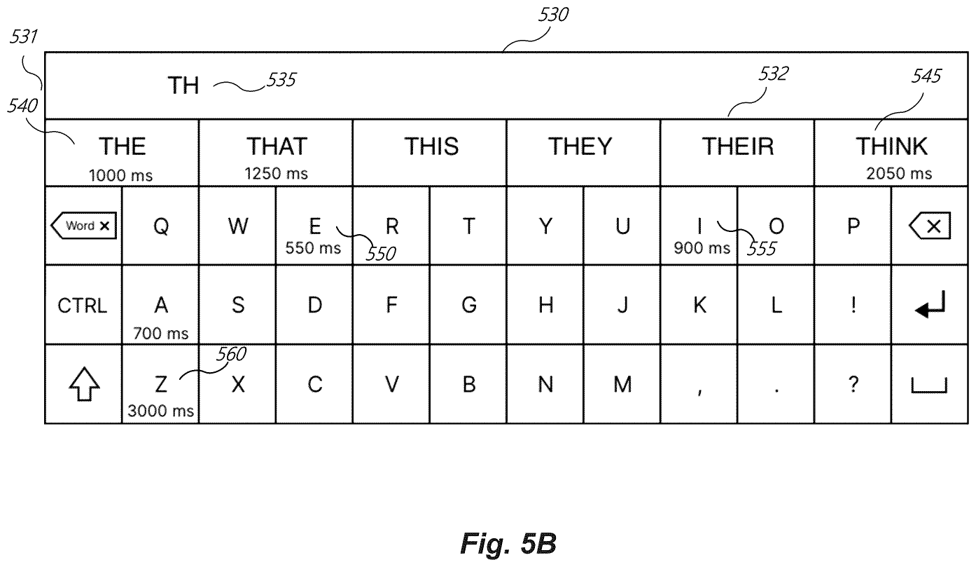

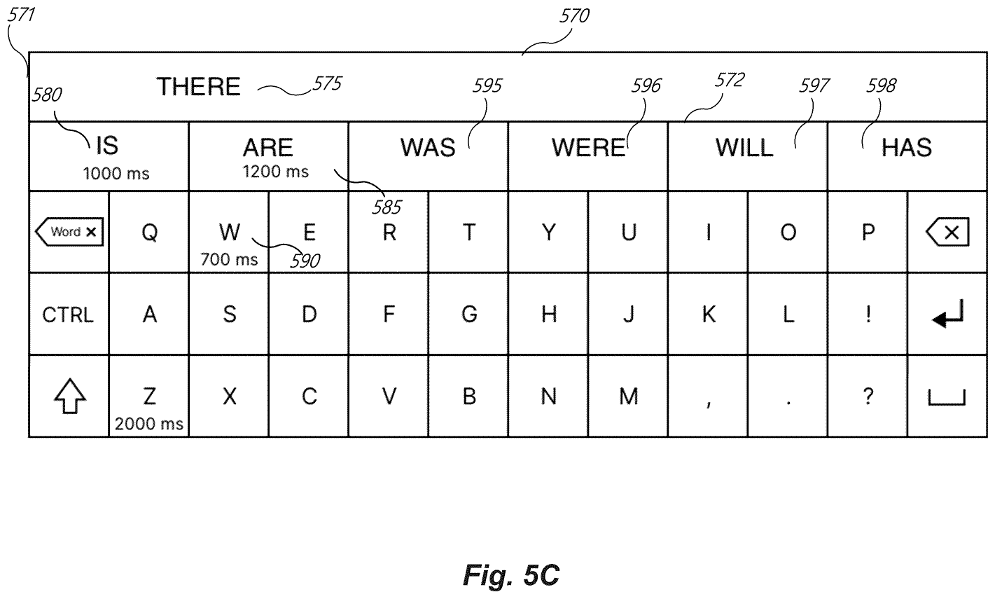

In summary, for a specific action to be determined and thereby actuated, the dwell duration or activation boundary is varied based on the probability, context, consequence, or proximity of that action relative to other possible actions. For example, if the EGDAS is implemented to control speech generation through use of a visual keyboard, the dwell duration required may vary (depending upon how the EGDAS logic is configured) depending upon frequency of use of a particular letter or symbol in the language being generated. Examples of this are discussed further with respect to FIGS. 5A-5C.

For ease of description, activation boundary is generally referred to herein as ‘dwell time,’ as dwell time is the most prevalent form of activation boundary in use today. As used in associate with the innovative techniques, methods and systems described here, ‘dwell time’ refers to any form of determination—e.g., to a simple timer duration, as well as to more complex techniques for determining activation such as the filtered gaze data, attracted gaze data, and “heat accumulation” techniques discussed above.

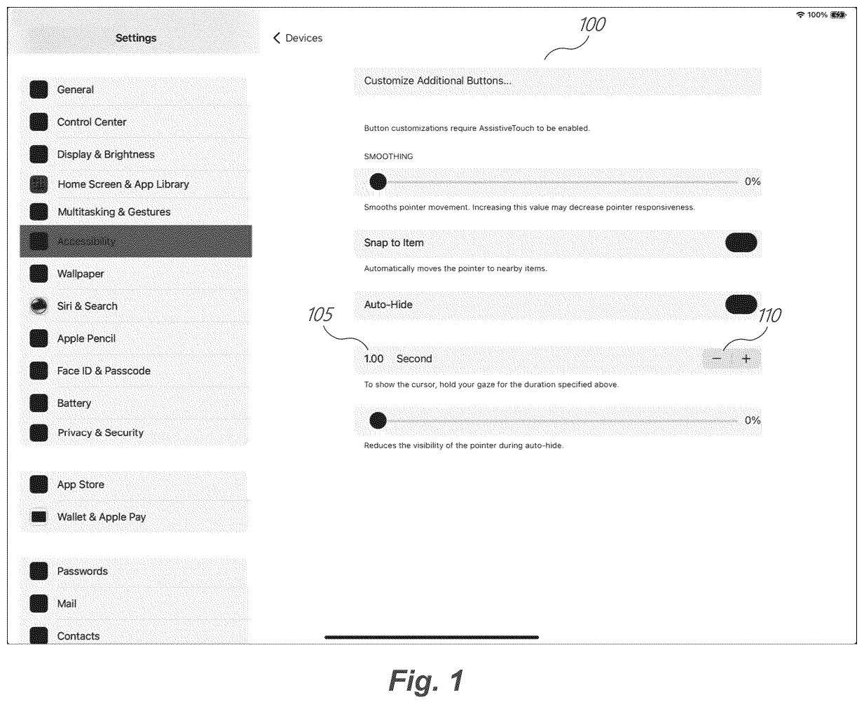

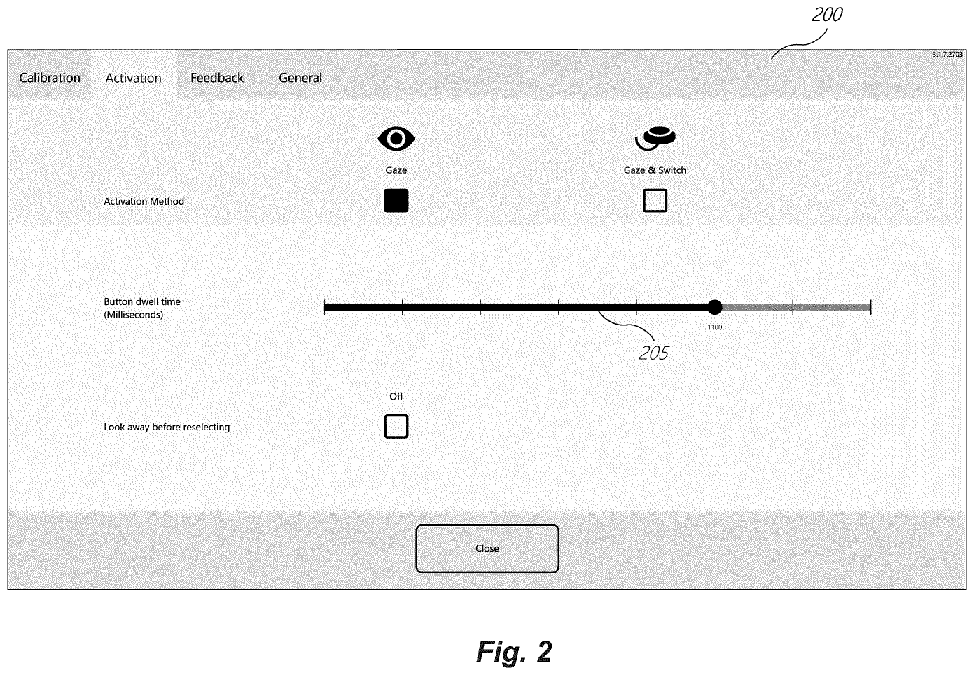

This is different determination than what is available with current systems where the dwell duration or activation boundary is only adjustable as a system wide parameter that causes a constant value of dwell time to be used across all visual elements in an application. FIGS. 1 and 2 provide two examples of current systems. FIG. 1 is a screen display of the Apple iPadOS Assistive Touch Eye Gaze Device settings display screen illustrating current state of the industry. (See, for example, “https://support.apple.com/guide/ipad/use-an-eye-tracking-device-ipad2cd35723/ipados#:˜:text=Go%20to%20Settings%20%3E%20Accessibility%20%3E%20Touch,if%20supported%20by%20you%20device”). In FIG. 1, display screen 100 which is part of the Settings dialog, allows a user to set system wide gaze duration 105 to 1.0 second, increasing it by intervals using the “−/+” button 110 to change the value (system wide). Similarly, FIG. 2 is a screen display of the Tobii Dynavox Eye Tracking settings display screen illustrating current state of the industry. (See for example, “https://download.mytobiidynavox.com/Computer%20Control/Documentation/Users%20Manual/TobiiDynavox_UsersManual_TDControl_en-US.pdf.) In FIG. 2, the settings screen display 200 allows a user to set a button dwell time using slider 205 to change the value (system wide).

In contrast to current systems, in the methods, systems, and techniques described here, dwell time for one or more aspects of an interface/device/object may be affected by probability, context (e.g., frequency or relative location), consequence, and/or proximity. An example of probability affecting dwell time occurs when an EGDAS is configured to use language model statistics such as frequency of occurrence to modify the dwell time needed to activate keyboard buttons based on the probability that the letter is used in the language being generated. For example, as described further below, to form English language words and sentences, the letter ‘E’ is used much more frequently than the letter ‘Q’ and therefore the dwell time needed to select ‘E’ is less than the dwell time needed to select ‘Q’.

An example of context affecting dwell time occurs when an EGDAS is configured to use language prediction models, word formation statistics, and sentence structure to modify the dwell time needed to activate keyboard keys as well as other action buttons such as word predictions and sentence completions. For example, when the person has previously selected (e.g., typed) the letters ‘TH’ and has previously selected the word ‘THERE’, the EGDAS can employ language model statistics of word formation and sentence structure (and predict probably outcomes) to modify the dwell time needed. For example, “THERE IS” is a more probable word pair in English than “THERE HAS,” so when the recent typing context contains “THERE”, the “IS” word completion button can be configured by the EGDAS to take less dwell time to activate than the “HAS” completion button.

An example of consequence affecting dwell time occurs when an EGDAS is configured to determine that different actions of a user interface have different (perhaps significant) differences in severity of consequences and thus modify the dwell time of certain actions to be more or less than others of differing consequences. For example, in an EGDAS that controls an airplane control system (real or simulation or game), different buttons may have significant differences in consequences (e.g., turn left versus eject). The EGDAS can employ models that assign greater dwell time to activate higher consequence actions (e.g., “EJECT”) than lower consequence actions (e.g., “TURN LEFT”).

An example of proximity affecting dwell time occurs when an EGDAS is configured to control different objects, such as devices with automation capabilities (such as home automation or IoT devices), based upon proximity of the person to the device being controlled. The EGDAS can incorporate a location model that modifies dwell time for selection/activation of a device based upon the proximity of the person to the home device being activated. For example, a “TV” button for activating a television in the same room as the person is located may be configured to have a lower dwell time than an “OPEN DOOR” button when the door is located in a different room.

It is noted that the techniques of incorporating variable dwell time and the EGDAS are generally applicable to any type of product that uses eye gaze to control a user interface or object or device. As well, different implementations can incorporate such techniques into software, hardware and/or firmware such as used for example, with controls such as smart glasses and headsets and powered equipment such as powered wheelchairs and other furniture. Essentially, the concepts and techniques described are applicable to any eye gaze controlled environment. Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a EGDAS System to be used to control a user interface or an IoT (or equivalent) object. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

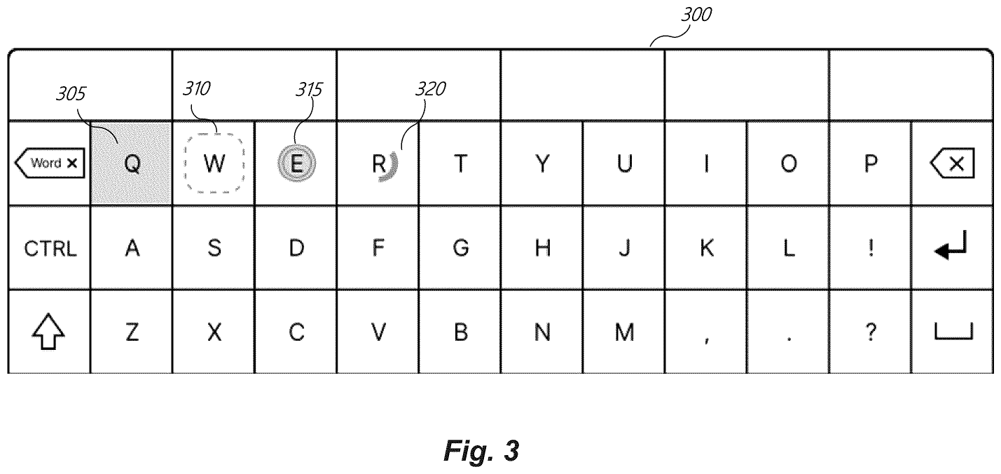

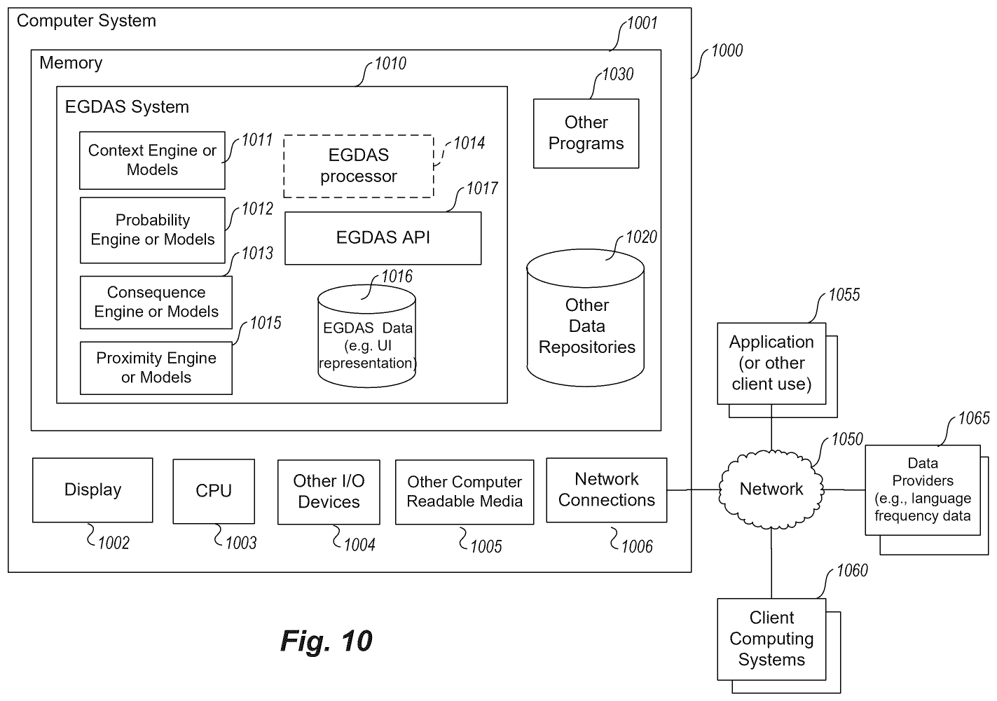

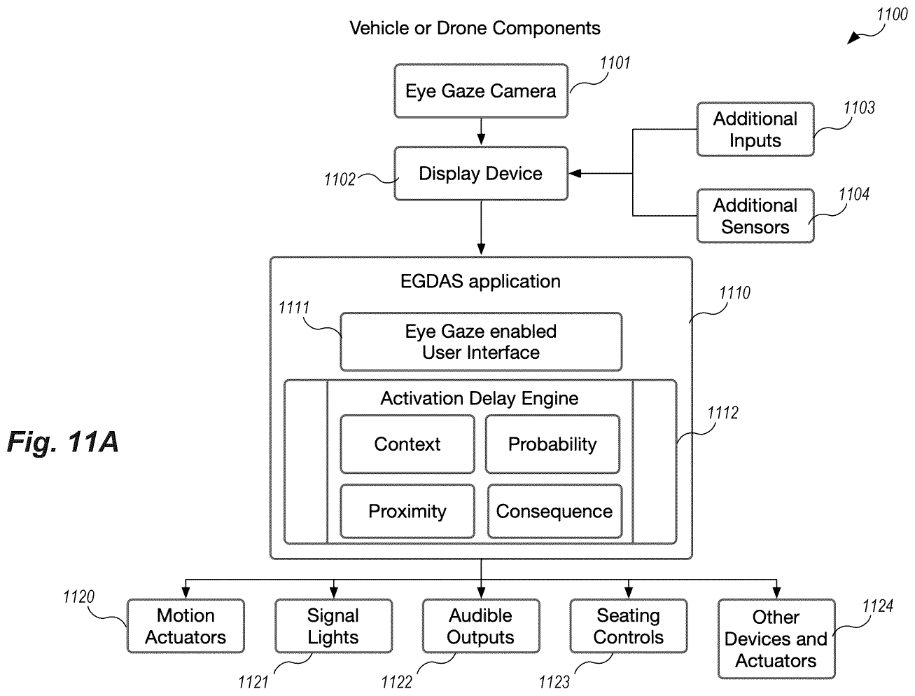

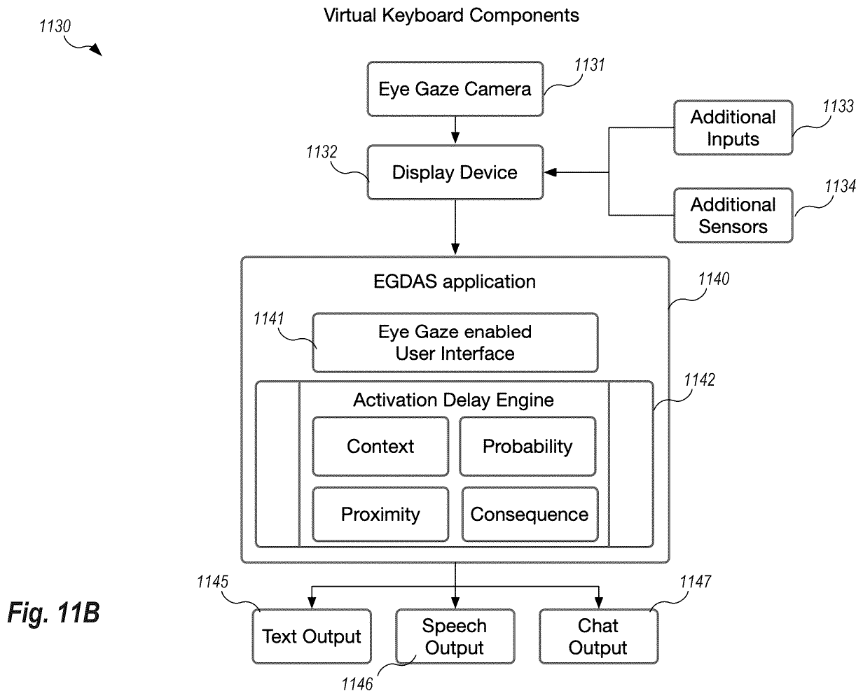

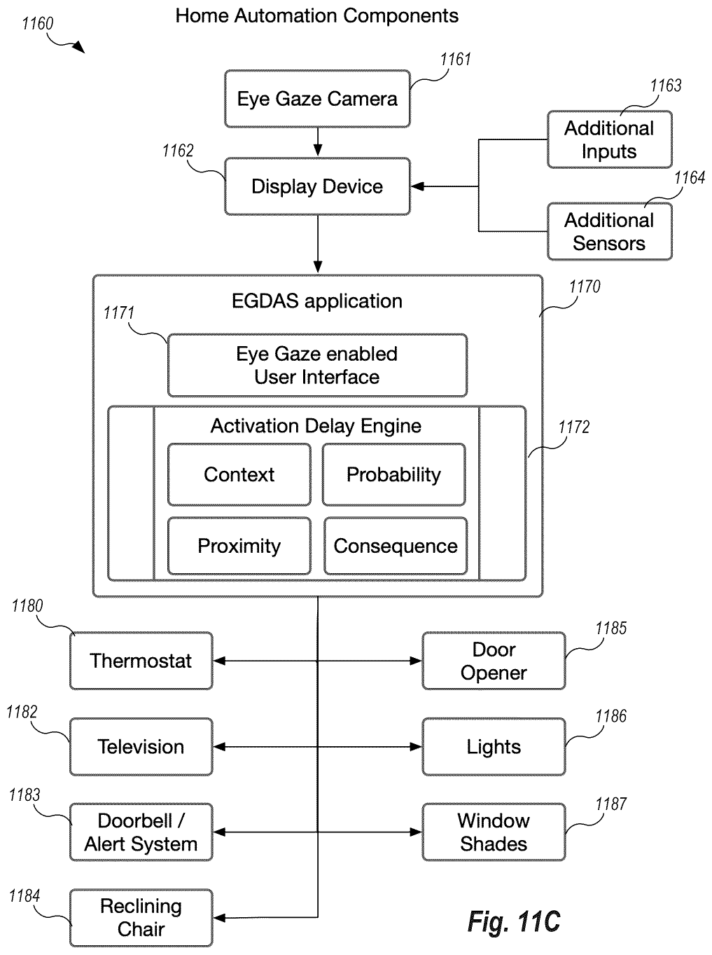

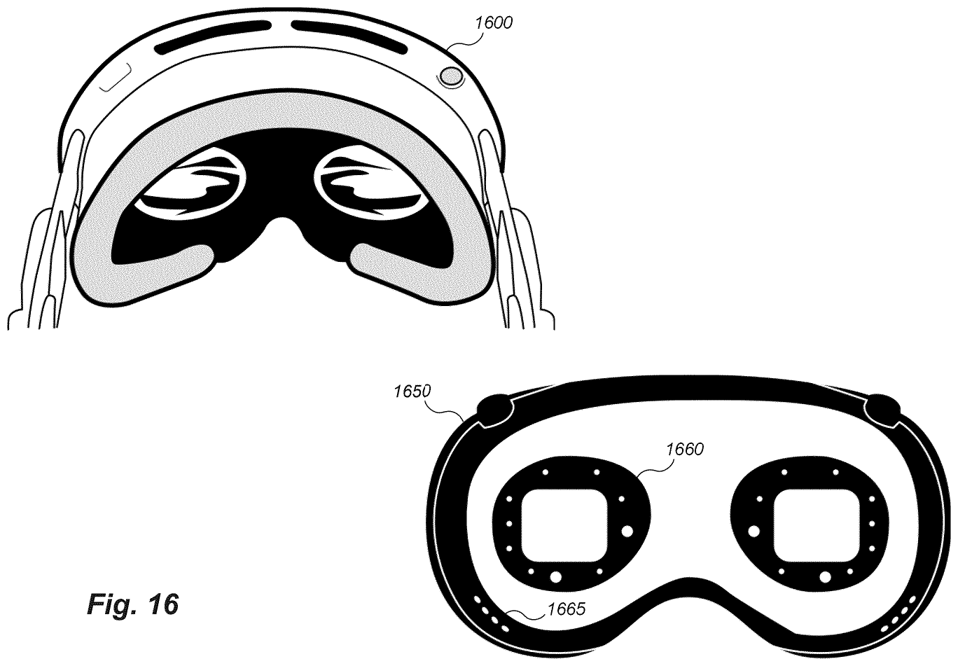

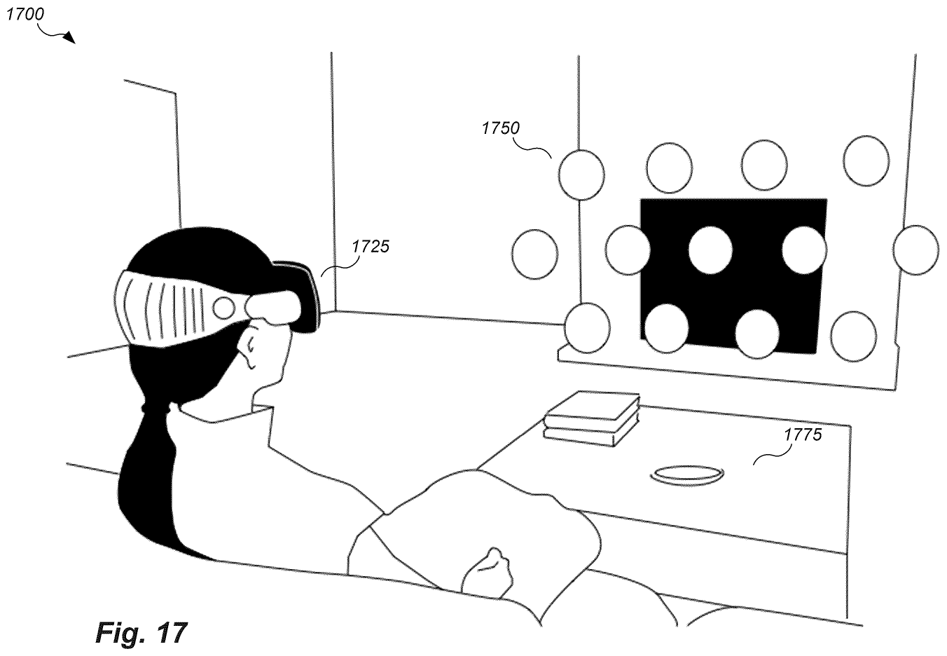

FIGS. 3-8 describe these particular examples in further detail. It is understood that other examples can be imagined and governed by the same principles and techniques described here. FIGS. 11A-14 describe other example implementations of an example EGDAS using variable dwell time for different deployment scenarios. FIG. 10 describes a computing system that may be used to implement a software, firmware, or hardware version of an example EGDAS. FIGS. 16-17 describes several environments that may incorporate EGDAS logic for controlling interfaces.

FIG. 3 is an example block diagram of an English QWERTY keyboard with several different styles of dwell delay activation states visualized. Keyboard 300 illustrates an English QWERTY keyboard with several different styles of dwell delay activation states visualized. These examples are merely illustrative of the many types of visualization or other feedback possible, including that auditory or haptic feedback may also be employed instead of or in addition to other types of feedback. Also, although multiple techniques are shown in a single illustrated keyboard, any particular deployment may choose to implement one or multiple techniques. For example, in FIG. 3, the ‘Q’ key 305 illustrates a modified background color (here gray) which, for example, may animate over time through a gradient color change, perhaps with a final bright color flash to indicate delay expiration and character key activation. As another example, the ‘W’ key 310 includes a border around the character glyph to show gaze activation and can be combined with other time-based visual animation techniques such as those described in this paragraph. As another example, the ‘E’ key 315 includes a filled in circle behind the character glyph which, for example, may animate to decrease size over time as the gaze delay expires. As another example, the ‘R’ key 320 includes a “pie slice” animation skeuomorphic design symbolizing a clock hand sweeping around the character glyph as the gaze delay ‘clock ticks down’. Other example visualizations and feedback can be similarly incorporated.

As mentioned earlier, an EGDAS may be configured to deploy dwell time for different interfaces based upon probability or context. For example, an EGDAS may implement a speech generation interface using a virtual keyboard and letter frequency to adjust dwell time for each key. Use of a dictionary for a chosen language, represents one of the many different techniques used to analyze language and use frequency (as described in FIGS. 4A-4B, or context as described in FIGS. 5A-5C) to determine the probability of a letter selection, the next letter in a word, the next word in a sentence, or the next sentence in a paragraph or discussion. It is not the only approach to language analytics relevant to EGDAS principles and techniques, yet it provides one example of the many different analytic techniques that can be incorporated into an EGDAS.

FIG. 4A illustrates an analysis of letter frequency probability based on the words contained in the Oxford English Dictionary. A table of letter probabilities 405 illustrates that according to the Oxford English Dictionary, ‘E’ is frequently used 11% of the time and ‘Q’ is infrequently used 0.2% of the time. A graph of these probabilities 410 shows the significant variance in the probability of letter usage in the English language according to this dictionary. More information can be found at “https://www3.nd.edu/˜busiforc/handouts/cryptography/letterfrequencies.html,” incorporated herein by reference.

FIG. 4B is an example block diagram of an English QWERTY keyboard with the statistical probability of each letter visible under each key. It is noted that different languages (and hence keyboards) will incorporate different frequencies for the characters and symbols of those languages. These probabilities can be derived from different statistical analyses, with some examples being a count of all letters used in the Oxford English Dictionary, a count of first letters of words from a dictionary, a count of letters in phrases commonly used in spoken or casual speech, a count of letters from transcriptions of voice conversations or social media posts, or any of the many different approaches taken together with statistical language modeling. Such analysis can include personalized language models that are generated or modified based on the past spoken phrases of the person using the device or statistics gathered externally, e.g., from their social communities. For example, people living with motor-neurological diseases may use medical phrases such as amyotrophic or Duchenne or dystrophy more commonly than the general population. Virtual QWERTY keyword 450 is shown with the statistical probability of each letter displayed below each key name. For example, the probability of the key labeled “E” 455 is “11.2%” and the probability of the key labeled “Q” 460 is “0.2%.” Thus, although the letters ‘E’ and ‘Q’ are near to each other in the layout of a QWERTY keyboard, the probability of each of these letters being used varies widely (11% vs. 0.2%).

FIG. 5A is an example block diagram of variable dwell times provided by an example EGDAS configured to incorporate variable dwell times using key probability as described in FIGS. 4A-4B. Specifically, virtual English QWERTY keyboard 500 is displayed with variable dwell times of each key (corresponding to a letter) underlaid with the length of the dwell time as adjusted by an EGDAS based on letter frequency probability with more statistically probable character keys having shorter dwell times. In this example, an average delay timing of 800 milliseconds is being used by the EGDAS. For example, the “D” key 515, which according to the Oxford English Dictionary letter statistical analysis is associated with a letter (“D”) that is in the median of the probability model, has an average gaze delay of 800 milliseconds. In contrast, “Q” key 510 has the gaze delay increased to 1500 milliseconds because its associated letter “Q” is more improbable than the average, and the “E” key 505 has a gaze delay decreased to 650 milliseconds because its associated letter “E” is more probable than the average. These dwell times are consistent with the frequency probabilities described with respect to FIG. 4B. Using these techniques, an EGDAS can configure gaze delay independently for each letter on the keyboard based on the statistical probability of the letter being used as determined by a language model. Any language model or probability to delay algorithm can be incorporated and mapped to a set of inputs in order to map probability to variable delay. In addition, an EGDAS may be configured to change the mappings and thus dynamically provide variable delays that can be modified or customized for a particular use or user.

Also as shown in FIG. 5A, the “word deletion” key 520 has been mapped to use a dwell time of 2000 msecs, which can be considered a “high gaze delay,” which is longer than the dwell times needed for pressing character keys. In an example EGDAS, this choice can be due to the lesser frequency of a user pressing that key, or as here to a greater consequence associated with that action (as described further below) or due to some other configuration aspect. Since the result of the action Delete Word is of higher consequence, e.g., it can accidentally undo the work of multiple previous keystrokes if invoked incorrectly, the mapping provides a longer invocation time to reduce the number of accidental activations. A longer delay, combined with a visual animation sequence that foreshadows activation as detailed in FIG. 3, allows the user to prevent an unintended word deletion by accidently moving their vision off the button after activation starts but before activation occurs.

An EGDAS also may be configured to deploy dwell time for different interfaces based upon context and/or consequence. FIG. 5B is an example block diagram of variable dwell times provided by an example EGDAS configured to incorporate variable dwell times using context for an English QWERTY keyboard interface. Here, the English QWERTY keyboard 530 is illustrated with a phrase in progress bar 531, a word prediction bar 532, showing the context of previously typed letters “TH”. The word prediction buttons 540-545 show an ordered list of the six most probable words (according to an example English language model) that start with the letters “TH” with button 540 corresponding to the word “THE” being the most probable word to occur in that context, and button 545 corresponding to the word “THINK” being the least probable word to occur in that context. Shown underneath the letters/words that correspond to buttons 540-545 are some example variable gaze delays based on the probability of the corresponding word occurring given the context of typing a word that starts with “TH”, where the gaze delay of the most probable word “THE” 540 is shown as being lower than that of the less probable word “THINK” 545.

Note that the gaze delay of the predicted words is typically higher than that of a key corresponding to an individual letter like “E” 550 or “I” 555 as the consequence of selecting a wrong word is higher than the consequence of selecting a wrong letter. However, in the example illustrated, in the case of a highly improbable letter like “Z” 560, the algorithm determining the gaze delay in an example EGDAS might have an individual key corresponding to a letter gaze delay be longer than that corresponding to a word. For example, the letter “Z” is highly unlikely not only because “Z” is infrequently used in English, but also because a word does not exist that begins with “THZ.” While the delay is high for “Z”, it is not infinite because there are situations such as proper names or scientific formulas, etc. where non-word letter combinations may be valid and useful. Note that the example timings are but one possible algorithm for combining linguistics, probability, and consequence aversion and not the only algorithm available to or configurable in an EGDAS.

FIG. 5C is another example block diagram of variable dwell times provided by an example EGDAS configured to incorporate variable dwell times using context for an English QWERTY keyboard interface. FIG. 5C illustrates a keyboard 570 with a phrase in progress bar 571 and a word prediction bar 572, showing the context of the word “THERE” previously typed or selected. The word prediction bar 572 shows words that commonly follow “THERE” in a sentence, including: “IS” (corresponding to button 580), “ARE” (corresponding to button 585), “WAS” (corresponding to button 595), “WERE” (corresponding to button 596), “WILL” (corresponding to button 597), and “HAS” (corresponding to button 598). A few example keys corresponding to letters and words show variable dwell times based on the statistical probability of each letter or word being next in the sentence. For example, the button 580 corresponding to the word “IS,” as the most likely next word, has a low gaze delay as compared to the button 585 corresponding to the word “ARE,” which is a less probable next word following the previous input THERE 575.

Of note, three predicted words “WAS”, “WERE”, “WILL” corresponding to buttons 595-597 all begin with the letter “W,” which has affected the probably of the key corresponding to the letter “W.” Thus, the gaze delay value for the “W” key 590 associated with the letter “W” now reflects a gaze delay that is under the median gaze duration for the typical QWERTY keyboard. This is an example of multiple levels of context (previously word typed, probable next words predicted, and individual letter frequency) affecting the probability model and therefore the gaze delay calculation. It also provides an example of dynamic modification of variable gaze delay.

Notably, this technique and concept can be further extended in several ways. For example, the mapping of context and probability to variable gaze delay can include predicting the fully completed phrase or the next phrase given the contextual words and letters typed. Or in progress, offering a list of a few possible phrases based on statistical language models or past conversational history or preferences of the user, and the like.

As another example extension, it is possible for an EGDAS to decrease the delay needed for corrective actions based on context. For example, while using eye gaze technology to type the word “HELLO,” the eye signal might have a random error in the data feed when gazing over the “E” key such that the eye signal instead is spread between the “E” key and the “W” key with the activation logic incorrectly selecting the letter “W.” A combination of the eye gaze data with a language model can be used to autocorrect the action results from “HWLLO” to “HELLO.” The contextual information used to determine the probability of appropriate autocorrection can be derived from multiple factors, such as the proximity of the “W” key to the “E” key, the following letters “LLO” in the word typing, and the small ‘edit distance’ between “HWLLO” and “HELLO,” sometimes referred to as a the “Levenshtein distance.” All such considerations can be used to affect the calculation of the gaze delay for a corrective action to replace “HWLLO” with “HELLO.”

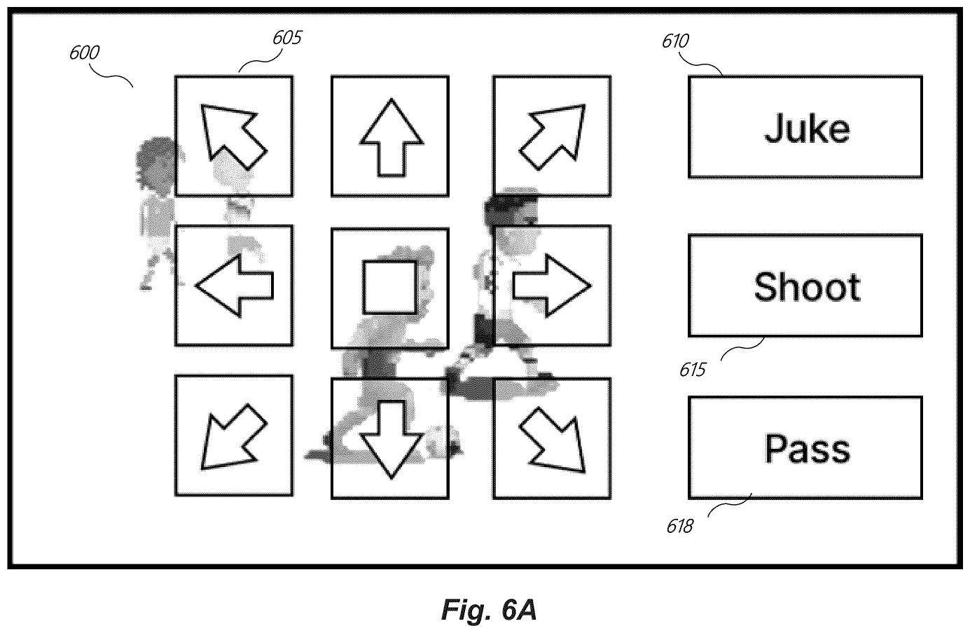

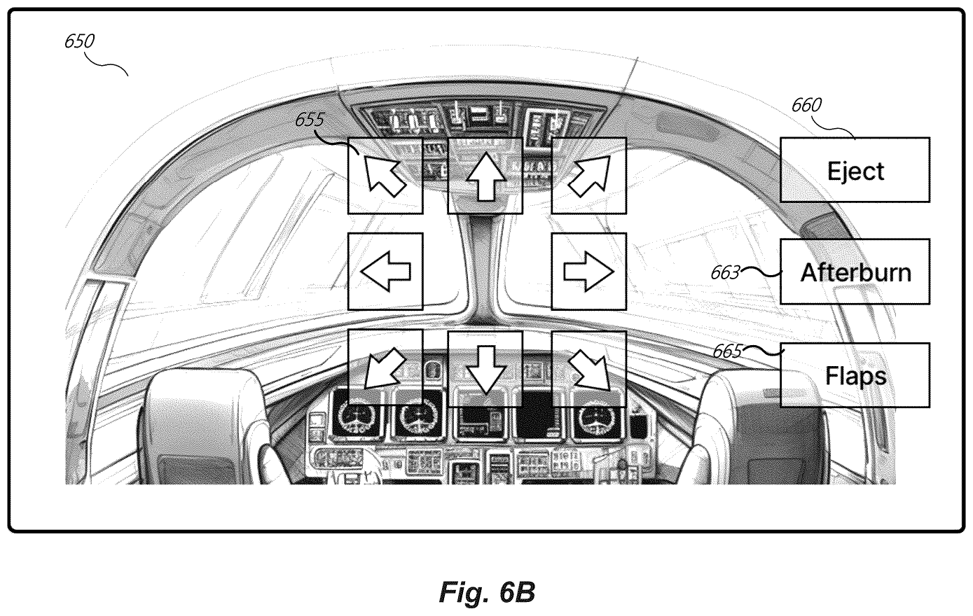

As mentioned, an EGDAS also may be configured to deploy dwell time for different interfaces based upon consequence beyond the speech generation context. FIG. 6A is an example user interface for a soccer simulation game with movement keys and action buttons that can be controlled by an example EGDAS configured to incorporate variable dwell times based upon consequence. In FIG. 6A, display 600 from a imagined game shows directional buttons (e.g., movement keys) 605 and action buttons 610, 615, and 618. Consequences to a user for choice of these different buttons relative to the gameplay varies (and may even vary over time) based upon how an EGDAS used to control the Ul with eye gaze technology is configured. For example, in one such implementation, movement key 605 or the “Juke” button 610 (to implement a dodge action) are of low consequence because, at least according to the rules of this simulation game, the player retains possession of the soccer ball while moving down the field. However, the “Shoot” button 615 or “Pass” action button 618 removes control of the soccer ball from the player (hopefully with a good game outcome). Therefore, the gaze delay for these action buttons should be configured to be longer than the movement or Juke button 610 due to difference in consequences to the player. This logic demonstrates that while the buttons may have different or similar looks or layout or functions, the gaze delay may vary more due to consequence than due to traditional look and feel.

FIG. 6B is an example user interface for an example aircraft control system with movement keys and action buttons that can be controlled by an example EGDAS configured to incorporate variable dwell times based upon consequence. In FIG. 6B, display 650 from an imagined simulator system shows directional buttons (e.g., movement keys) 655 and action buttons 660, 663, and 655. Similar to the example described with respect to FIG. 6A, the gaze delay of the action buttons 660, 663, and 665 will vary due to consequence, with the “Flaps” function invoked by “Flaps” button 665 having more consequence than basic movement conducted via buttons 655 because flaps can be damaged if deployed at high speeds. Higher consequence actions like Eject are then associated with a longer gaze delay than movement buttons 655 or Flaps button 665.

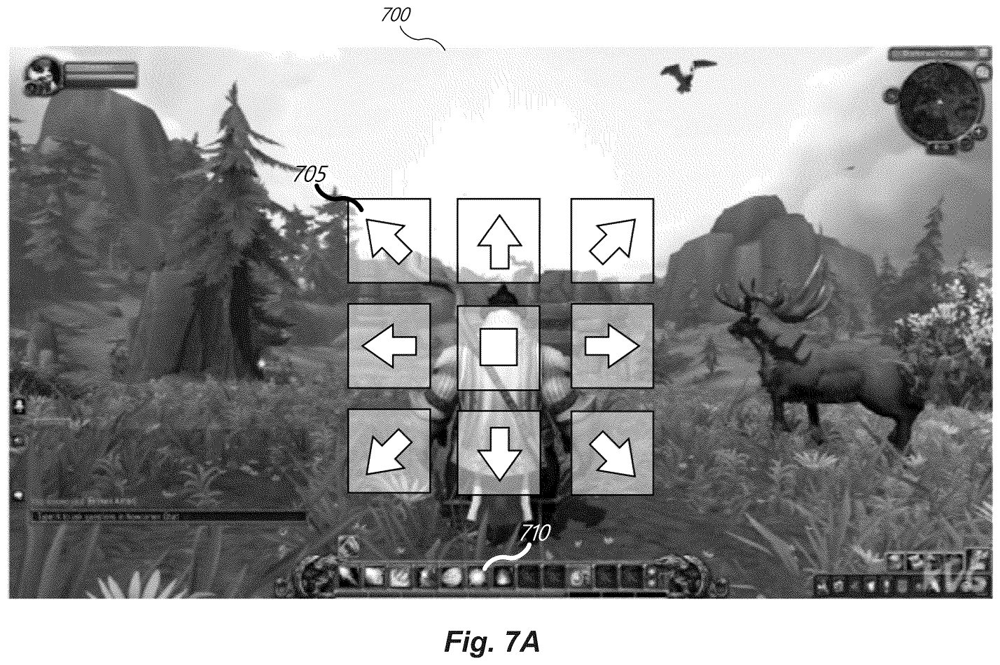

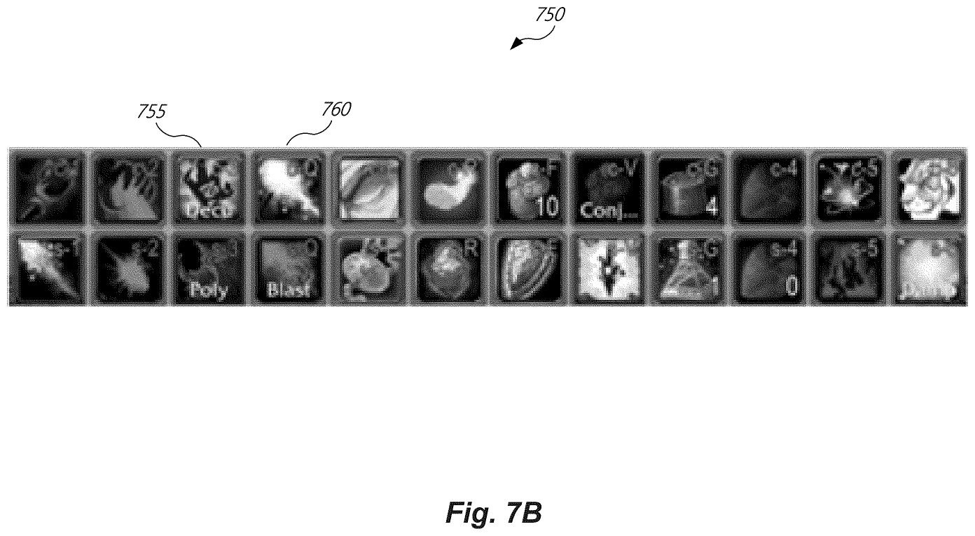

Different use scenarios can vary dwell time based upon one or more factors such as probability (or frequency), context, consequence, proximity, or even other factors. FIGS. 7A and 7B are an example user interface for a virtual adventure game with movement keys and an action bar that can be controlled by an example EGDAS configured to incorporate variable dwell times based upon consequence, probability, and/or proximity. The interface 700 shown in FIG. 7 is from a virtual adventure game known as “World of Warcraft” with directional buttons (movement keys) 705 and an action bar 710 of possible actions that can be taken by the player. (See “https://worldofwarcraft.blizzard.com/en-us/start.”) To provide variety and challenge in game play, some actions are configured to have greater effect when used sequentially, a technique known in the gaming industry as “Action Chains.”

In FIG. 7B, action bar 750 is close-up of the action bar 710 shown in FIG. 7A illustrating contextual action chains that may be controlled by an example EGDAS and configured to vary dwell time based upon the probability (and therefore the dwell delay) of the keys in the action bar 750. For example, an action such as “make vulnerable to fire” associated with button 755, when used prior to the “light 'em up” action associated with button 760 will cause the “light 'em up” action to cause more damage to the target. In this case, the EGDAS can be configured to determine that the context of having previously activated the “make vulnerable to fire” action would reduce the gaze delay needed to activate the follow-up action “light 'em up” in the action chain.

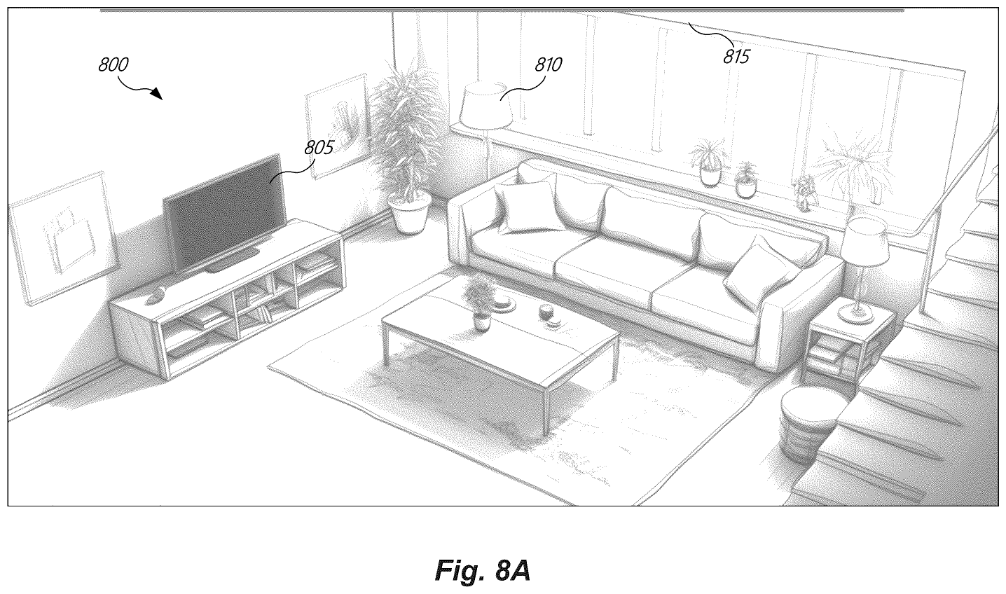

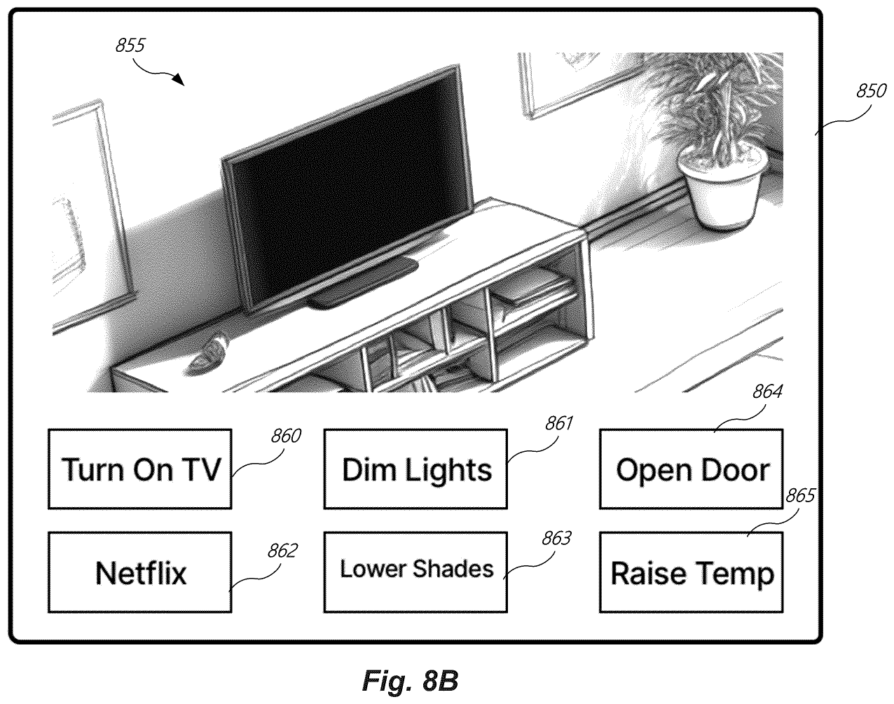

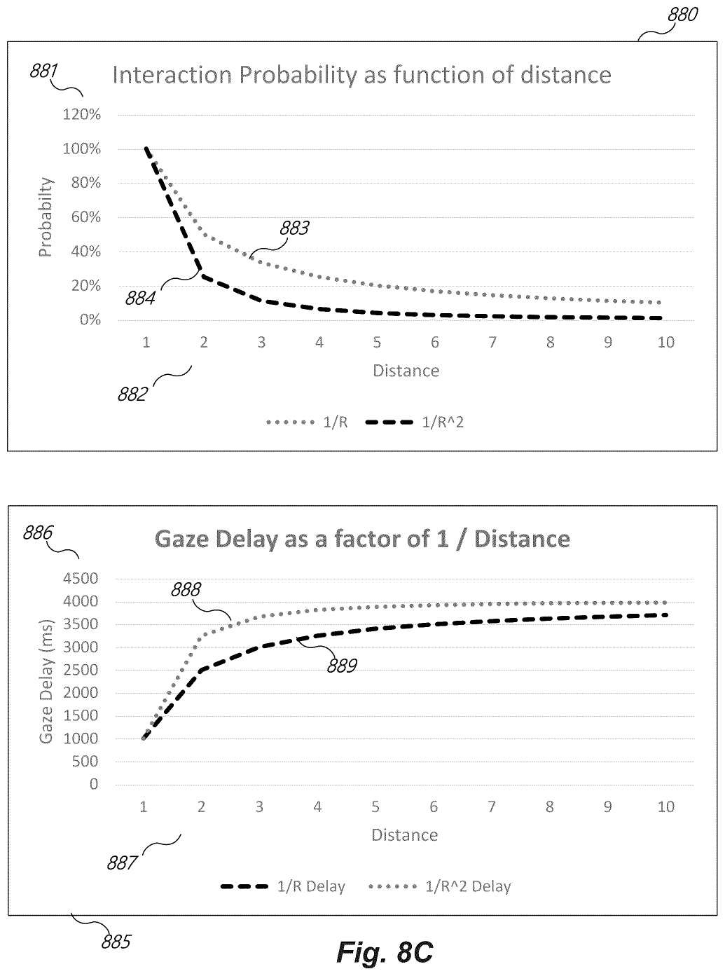

As another example, FIGS. 8A-8C present an example user interface for controlling automatically controllable devices such as home automation controllable devices or other IoT devices. Of note, these devices may be located in environments other than a home, such as a workplace, factory, or the like. FIG. 8A is an example block diagram of a room filled with example automation controllable devices. The illustrated room 800 includes multiple devices such as a television 805, a light 810, and curtains 815. Not pictured in this room is a door with an automatable door opener and, for purposes of this example, the door is located in a remote room of the house (in a different location from the person controlling the devices using the eye gaze device).

FIG. 8B is an example block diagram of an example user interface using buttons to control automation devices in a location by an example EGDAS configured to incorporate variable dwell times based upon context, probability, proximity or other factors. Here, an eye gaze enabled device, such as a TobiiDynavox iSeries speech device or an Apple Vision Pro, is configured (using the EGDAS techniques) to control the devices in room 800 shown in FIG. 8A. This example EGDAS implementation illustrated in display 850 shows a contextual view of the local environment and automatable devices 855 and a series of action buttons 860-865 that can be used to control the automatable devices for example connected to the eye gaze interface using a connection such as wirelessly, via Bluetooth, etc. Each of the buttons 860-865 may be associated with varied and/or variable dwell times based upon context and/or proximity. For example, the “Turn on the TV” activating button 860 associated with activating the TV can create a context that increases the probability that the user will want to dim the lights, play Netflix, or lower the shades. Accordingly, the EGDAS can be configured to change the gaze dwell time associated with the “Dim Lights,” “Netflix,” or “Lower Shades” actions by decreasing the gaze dwell time for the associated buttons 861-863 while leaving unchanged the gaze dwell time for non-related actions like the “Open Door” action associated with button 865 or the “Raise Temp” action associated with button 865.

As mentioned, an EGDAS can also be configured to incorporate variable dwell time based upon proximity. FIG. 8C is a visualization showing multiple graphs that illustrate a mathematical relationship of dwell time to a user's distance or proximity to a device being actuated, for example, using the interface of FIG. 8B. As described in FIGS. 8A and 8B, the eye gaze enabled system may be located in a room filled with home automation controllable devices where the distance from the eye gaze system to the home automation devices varies from device to device. The device (e.g., the EGDAS configured to implement the user interface for the device) can be configured to vary the dwell time for the buttons used to control the devices based upon these proximity distances. For example, the EGDAS can be configured to associate lower dwell times for the buttons that control devices closer to the eye gaze system (the user) than those buttons that control devices farther from the eye gaze system (the user). Graph 880 demonstrates several possible mathematical functions relating distance (axis 882) to probability of actuation (axis 881), in this example with two possible quadratic equations such as

$$( a ) Probability = \frac{1}{Distance} ( demonstrated by line 883 ) \\ and \\ ( b ) Probability = \frac{1}{{Distance}^{2}} ( demonstrated by line 884 )$$

Graph 885 demonstrates how this probability could be quadratically related to dwell time for activation using the quadratic equation:

$$( c ) Dwell Time ( ms ) = 4000 ms - ( 3000 ms * Probability ) .$$

Here axis 886 represents gaze delay (dwell time) and axis 887 represents distance. Lines 888 and 889 represent these quadratic relationships. These graphs illustrate just a few of the many potential mathematical relationships that can be used to map proximity distance to dwell time for activation. It is noted that an EGDAS can be configured to incorporate many other mathematical relationships.

Device proximity can be determined in many ways, from direct detection due to signal strength of wireless transmissions from the device to intentional location radiators similar to Apple Air Tag transponders or other wireless “find my” locators or by other means of indoor localization or visual object detection. In the example describe with reference to FIG. 8B, the person is near the television 855 and the relative distance 885 can be determined using one of these proximity techniques. This proximity can be used to infer the intention to interact with the device and therefore decrease the gaze delay (dwell time) needed to initiate action via the “Turn on TV” button 860. Conversely, a determined distance (proximity) to the door opener, which in this example is located in a different room of the house, can be used to increase the gaze delay (dwell time) necessary to activate the “Open Door” button 864.

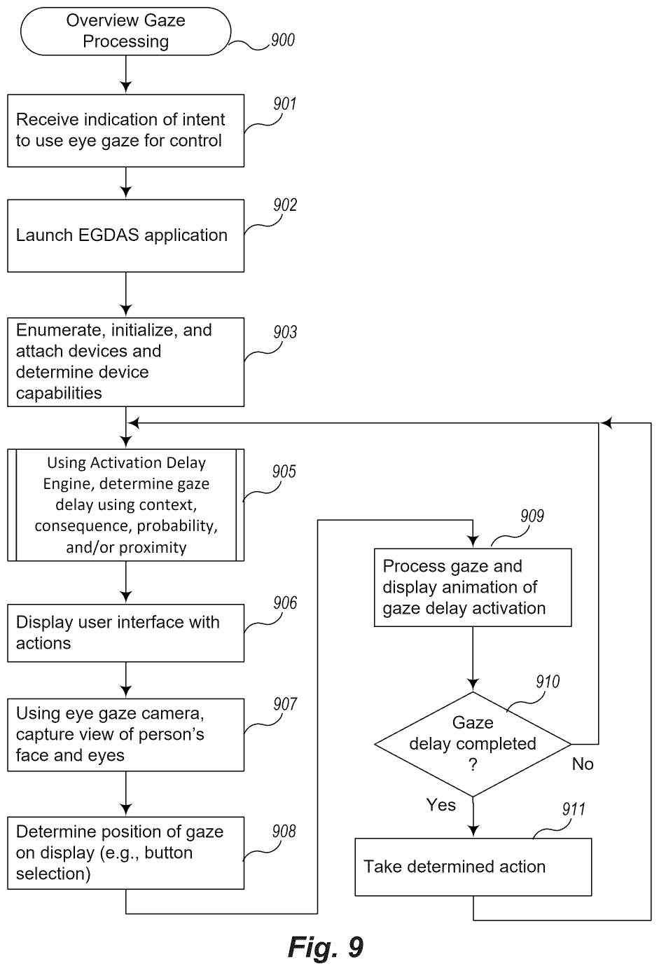

FIG. 9 is an overview flow diagram of the logical behavior of an example Eye Gaze Dwell Activation System. The example EGDAS is programmed to implement system control using an activation delay engine to vary the activation time needed to interact with user interface elements based on context, consequence, probability, and/or proximity.

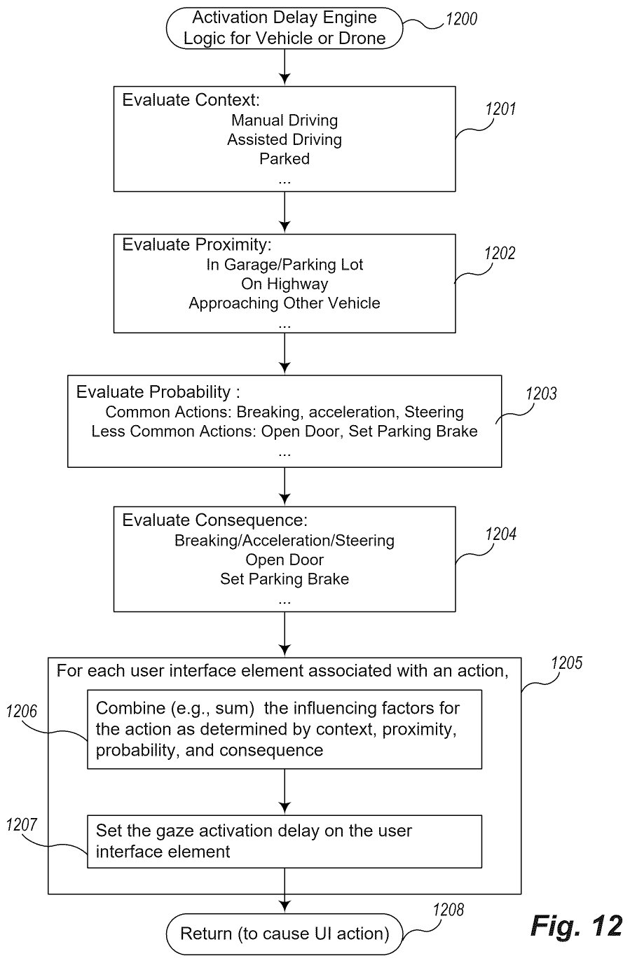

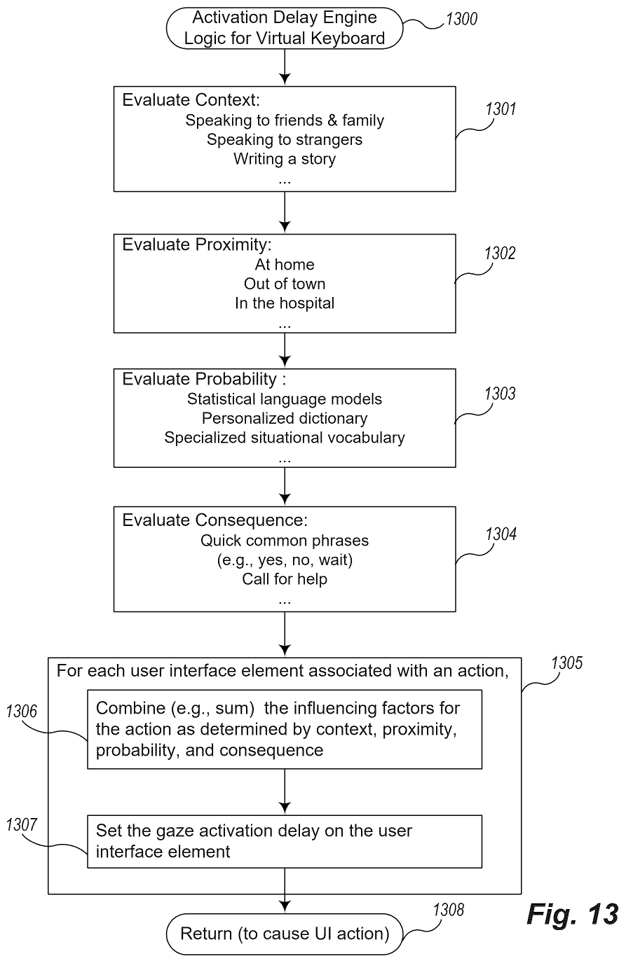

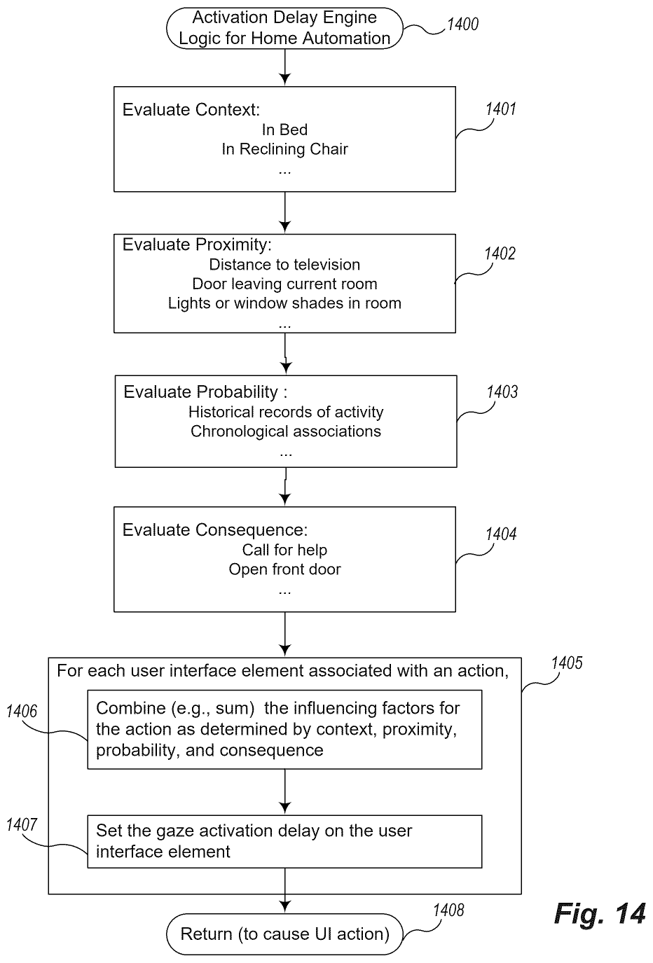

More specifically, the EGDAS logic has received indication of intent to use eye gaze for control in logic block 901. In block 902, the EGDAS application is launched. In block 903, the EGDAS logic enumerates, initializes, and attaches devices and determines device capabilities. In block 905, the EGDAS logic invokes its activation delay engine (a logic portion of the EGDAS) to determine eye gaze using one or more of context, consequence, probability, and/or proximity to determine delay times. The activation delay engine varies in its approach to determining specific dwell times based on the application at hand. FIGS. 12-14 describe examples of such activation delay engine behavior. For example, different context and probability calculations are used for a vehicle driving system described in FIG. 12 than for a virtual keyboard described in FIG. 13, than for a home automation control system described in FIG. 14.

Once the gaze delay is determined by the activation delay engine, the user interface is presented with visual elements and their associated actions (block 906). The dwell times determined by the activation delay engine may change over time as the context changes. For example as a vehicle exits a driveway and enters a roadway, the context of the vehicle's potential actions and their consequences change and therefore the dwell times will change. When driving down a road, the consequence of opening a car door is different than when the car is parked, as is the probability that a driver would choose to open a car door when driving versus parked.

As the calculated dwell times change as a result of logic block 905, this may be reflected in how the user interface in block 906 is presented. For example, visual hints such as a glowing border (suggesting likely) or greyed out/diminished visualization (suggesting unlikely) may help visualize the low or high dwell times needed to activate the visual element and take the action.

In block 907, the EGDAS logic uses the eye gaze camera to capture a view of the user's face and eyes. In block 908, the EGDAS determines the position of the gaze on the display, for example a user interface control selection. In block 909, the logic processes the gaze and display animation of gaze delay activation, for example, as described with reference to FIG. 3. Then, in block 910, if the gaze delay previously determined has been completed, the logic proceeds in block 911 to take/implement the determined action; otherwise, continues back to calling the activation delay engine in block 905 to redetermined gaze delay.

The action taken in block 911 varies widely based on the system being controlled by the EGDAS. The action could be anything including causing text to be typed from a virtual keyboard, interacting with a virtual world through a game/simulation's avatar to raising, or lowering the flaps on a teleoperated aircraft. Once the action is complete or abandoned, the logic returns to block 905 to redetermined gaze delay and updating the user interface.

FIG. 10 is an example block diagram of an example computing system for practicing embodiments of an Eye Gaze Dwell Activation System described herein. Note that one or more general purpose virtual or physical computing systems suitably instructed or a special purpose computing system may be used to implement an EGDAS. Further, the EGDAS may be implemented in software, hardware, firmware, or in some combination to achieve the capabilities described herein.

Note that one or more general purpose or special purpose computing systems/devices may be used to implement the described techniques. However, just because it is possible to implement the EGDAS on a general purpose computing system does not mean that the techniques themselves or the operations required to implement the techniques are conventional or well known.

The computing system 1000 may comprise one or more server and/or client computing systems and may span distributed locations. In addition, each block shown may represent one or more such blocks as appropriate to a specific embodiment or may be combined with other blocks. Moreover, the various blocks of the Eye Gaze Dwell Activation System 1010 may physically reside on one or more machines, which use standard (e.g., TCP/IP) or proprietary inter-process communication mechanisms to communicate with each other.

In the embodiment shown, computer system 1000 comprises a computer memory (“memory”) 1001, a display 1002, one or more Central Processing Units (“CPU”) 1003, Input/Output devices 1004 (e.g., keyboard, mouse, CRT or LCD display, etc.), other computer-readable media 1005, and one or more network connections 1006. The EGDAS 1010 is shown residing in memory 1001. In other embodiments, some portion of the contents, some of, or all of the components of the EGDAS 1010 may be stored on and/or transmitted over the other computer-readable media 1005. The components of the Eye Gaze Dwell Activation System 1010 preferably execute on one or more CPUs 1003 and manage the eye gaze controlled user interfaces implementing variable dwell time as described herein. Other code or programs 1030 and potentially other data repositories, such as data repository 1006, also reside in the memory 1001, and preferably execute on one or more CPUs 1003. Of note, one or more of the components in FIG. 10 may not be present in any specific implementation. For example, some embodiments embedded in other software may not provide means for user input or display.

In a typical embodiment, the EGDAS 1010 includes one or more context engines and/or models 1011, one or more probability engines and/or models 1012, one or more consequence engines and/or models 1013, and one or more proximity engines and/or models 1014. In at least some embodiments, the proximity engine (that determines proximity) is provided external to the EGDAS and is available, potentially, over one or more networks 1050. Other and/or different modules may be implemented. In addition, the EGDAS may interact via a network 1050 with application or client code 1055 that uses the values of the variable dwell time determined by one of the engines 1011-1014 for example, for reporting or logging purposes. The EGDAS may also interact via the network 850 with one or more client computing systems 1060, and/or one or more third-party information provider systems 1065, such as the purveyors of information used in the data repository 1016 or in the engines/models 1011-1014. Also, of note, the EGDAS data repository 1016 may be provided external to the EGDAS as well, for example in a knowledge base accessible over one or more networks 1050. For example, the EGDAS data repository 1016 may store device or user specific data for use in customizing the variable dwell times associated with various user interfaces.

In an example embodiment, components/modules of the EGDAS 1010 are implemented using standard programming techniques. For example, the EGDAS 1010 may be implemented as a “native” executable running on the CPU 103, along with one or more static or dynamic libraries. In other embodiments, the EGDAS 1010 may be implemented as instructions processed by a virtual machine. A range of programming languages known in the art may be employed for implementing such example embodiments, including representative implementations of various programming language paradigms, including but not limited to, object-oriented, functional, procedural, scripting, and declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the EGDAS 1010 (e.g., in the data repository 1016) can be available by standard mechanisms such as through C, C++, C#, and Java APIs; libraries for accessing files, databases, or other data repositories; through scripting languages such as XML; or through Web servers, FTP servers, or other types of servers providing access to stored data. The data repository 1016 may be implemented as one or more database systems, file systems, or any other technique for storing such information, or any combination of the above, including implementations using distributed computing techniques.

Also the example EGDAS 1010 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an EGDAS.

Furthermore, in some embodiments, some or all of the components of the EGDAS 1010 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

As described in FIG. 9, one of the functions of a EGDAS is to determine eye gaze activation delay time. Also as described, delay determination can be varied based upon context, consequence, probability, and/or proximity as well as by the particular environment in which the EGDAS is deployed. FIGS. 11A-C described several example deployments of an example EGDAS. FIGS. 12-14 described example logic of the activation delay engines in these example EGDAS deployments.

More specifically, FIG. 11A is an example block diagram of components of a vehicle or drone system that deploys an example Eye Gaze Dwell Activation System for operating a vehicle or drone. The vehicle/drone environment 1100 comprises an eye gaze camera 1101, a display device 1102, other inputs 1103, additional sensors 1104, and an EGDAS application deployment 1110. The EGDAS comprises an eye gaze enabled user interface of some nature 1111, and an activation delay engine 1112 described further with respect to FIG. 12. In this example, the EGADS 1110 takes actions upon the devices in the vehicle including but not limited to the motion actuators 1120 (engine, steering, propulsion system, control surfaces, etc.), signal lights 1121, audible outputs 1122 (speakers, buzzers, etc.), seating controls 1123, and other controls 1124 (e.g., door controls), etc.

FIG. 11B is an example block diagram of components of a virtual keyboard that deploys an example Eye Gaze Dwell Activation System for controlling the virtual keyboard. The virtual keyboard environment 1130 comprises an eye gaze camera 1131, a display device 1132, other inputs 1133, additional sensors 1134, and an EGDAS application deployment 1140. The EGDAS comprises an eye gaze enabled user interface of some nature 1141, and an activation delay engine 1142 described further with respect to FIG. 13. This virtual keyboard could be part of a general purpose computing system (such as a desktop or tablet computer), an AR/VR system, or a dedicated medical device such as a speech generating device that generates, for example, text output 1145 (e.g., writing a document or web page), speech output 1146 (generating synthetic speech for a person with a verbal disability), or chat output 1147 (for example interacting with social media or texting with friends & family).

FIG. 11C is an example block diagram of components of a home automation system that deploys an example Eye Gaze Dwell Activation System for operating the home automation system. The home automation system 1160 comprises an eye gaze camera 1161, a display device 1162, other inputs 1163, additional sensors 1164, and an EGDAS application deployment 1170. The EGDAS comprises an eye gaze enabled user interface of some nature 1171, and an activation delay engine 1172 described further with respect to FIG. 14. In this example, the EGDAS connects to and interacts with a suite of home automation devices such as electronic thermostats 1180, television 1182, or doorbell/alert systems 1183, reclining chair 1184, door opener 1185, lights 1186, window shades 1187, and other remote controllable devices. In this example, the consequence of changing a temperature is typically lower than that of signaling a ‘I need help’ alert, so the EGDAS may generate a lower gaze delay for the thermostat control 1180 than that of the alert system signal 1183.

FIG. 12 is an example flow diagram for determining activation delay in an example Eye Gaze Dwell Activation System for operating a vehicle or drone. In this example, the four influencing factors in determining gaze delay are context, proximity, probability, and consequence. In different implementations, one or more of these more be more important than others. The activation delay logic 1200 evaluates context in block 1201, evaluates proximity factors in block 1202, evaluates probability factors in block 1203, and evaluates consequences in block 1204.

For example, evaluation (e.g., which may include determining and calculating) of contextual factors 1201 could include is the vehicle being driven manually, assisted aka semi-autonomous mode, or is it parked? For example, when the vehicle is parked, the probability that an ‘open door’ action will be used is higher than when manually driving the car. These contextual factors can be determined from the current operating state of the car (e.g. is the vehicle transmission in park, are the driving assistance systems engaged or disengaged, etc.) or from actions previously taken (e.g. has the button to change the transmission from park to drive been pressed). Factors 1201 include some of the many possible such factors.

Evaluation of proximity factors 1202 could include is the vehicle in a parking lot, in a garage, or driving down the highway? These factors could be determined using sensor suites such as GPS location tracking with navigation maps or visual sensors that visually recognize and classify the environment the vehicle is currently in. Proximity evaluation could also include factors such as is the vehicle approaching another vehicle or obstacle which could be determined from build in sensor suites or obstacle detectors. Factors 1202 include some of the many possible such factors.

Evaluation of probability factors 1203 could include static knowledge or rules such as “when in drive mode, it's common to steer, brake, and accelerate” or “it's uncommon to deploy the parking brake when driving down the road at 15+ mph”. This could involve dynamic or learned knowledge such as “this driver uncommonly accelerates past 35 mph when driving down country roads”. Factors 1203 include some of the many possible such factors.

Evaluation of consequence factors 1204 include knowledge such as “deploying the parking brake when going 35+ mph will damage the vehicle” or “accelerating when there is another vehicle 5′ ahead may cause damage”. Factors 1204 include some of the many possible such factors.

Once the context, proximity, probability, and consequence factors are evaluated, the activation delay engine logic 1200 then in block 1205, for each user interface element associated with an action, combines these influencing factors in block 1206 and using this result, in block 1207, to modify/set a corresponding gaze activation delay for each of the user interface elements. The logic then returns (as for example, described in FIG. 9).

This combining process may be as simple as an additive function, or it may be a more complicated polynomial or other mathematical function between factors including, for example weighting the factors prior to combining them.

For example, consider a snapshot in time of an EGDAS system controlling a car driving down the road at 30 mph in a 35 mph zone with a truck in the same lane 5′ in front of the car. What might the gaze delay be to activate an ‘accelerator’ button? One possible example of eye gaze delay and associated factors could be:
2000 milliseconds system default gaze delay
−35% delay time for accelerating while the car is in drive
−15% delay time for accelerating while going 30 mph in a 35 mph speed zone
+400% delay time for accelerating while a truck is 5′ in front of the car
   Then, the combined gaze delay could be computed as:

$$Gaze Delay With Factors = 2000 ms \times ( 100 \% - 35 \% - 15 \% + 400 \% ) \\ GDWF = 2000 ms \times 450 \% = 9000 milliseconds$$

FIG. 13 is an example flow diagram for determining activation delay in an example Eye Gaze Dwell Activation System for a virtual keyboard used to generate text. In this example, the four influencing factors in determining gaze delay are context, proximity, probability, and consequence. In different implementations, one or more of these more be more important than others. The activation delay logic 1300 evaluates context in block 1301, evaluates proximity factors in block 1302, evaluates probability factors in block 1303, and evaluates consequences in block 1304.

For example, evaluation of contextual factors 1301 could include the context of the typing or conversation; is the person writing a story, speaking to friends & family, or speaking more formally to strangers? This can be determined automatically (e.g. the Microsoft Word application is currently in focus on the computer, so we are in writing mode) or manually (e.g., the user selects a ‘causal conversation’ switch to change the language context in use). Automatic determination could involve using other sensors or inputs to infer a context (e.g. the person's spouse is in view of a web camera or their Apple Watch's Bluetooth signal can be detected nearby, therefore the EGDAS is in a “friends & family conversation” context). Factors 1301 include some of the many possible such factors.

Evaluation of proximity factors 1302 may use various forms of location services such as GPS signals or cell phone tower transmission reception to determine the proximity context to use, such as “at home conversation” vs. “in the hospital, speaking formally to doctors and nurses”. Factors 1302 include some of the many possible such factors.

Evaluation of probability factors 1303 could use statistical language models such as highlighted in FIG. 4A to influence individual keys or word selection probability. This may also include personalization to modify probabilities such as a person who overuses the phrase “wicked cool” or who commonly speaks to their dog “Fluffly Bumpkins”, as neither of these words or phrases appears commonly in the Oxford English Dictionary. This also may include specialized situational vocabulary that is applicable to a person in a context that would otherwise be a rarely used turn of phrase, such as a person who is living with a motor neuron disability who during a hospital visit frequently uses the phrases or words “amyotrophic lateral sclerosis” or “pulmonary”. Factors 1303 include some of the many possible such factors.

Evaluation of consequence factors 1304 examples may include ‘quick phrases’ that are frequently needed and commonly used, such as simple concepts of “Yes”, “No”, or “Wait for me to speak” which need to be readily selectable and have low negative outcomes if accidentally selected. Conversely, a phrase may be both high frequency but also high consequence for accidental use such as “I need help now!” which would bring a combination of factor modifications into play. Factors 1304 include some of the many possible such factors.

Once the context, proximity, probability, and consequence factors are evaluated, the activation delay engine logic 1300 then in block 1305, for each user interface element associated with an action, combines these influencing factors in block 1306 and using this result, in block 1307, to modify/set a corresponding gaze activation delay for each of the user interface elements. The logic then returns (as for example, described in FIG. 9). As described with respect to FIG. 12, combining may involve summation, weighted combinations, as well as different mathematical functions.

FIG. 14 is an example flow diagram for determining activation delay in an example Eye Gaze Dwell Activation System for operating a home automation system. In this example, the four influencing factors in determining gaze delay are context, proximity, probability, and consequence. In different implementations, one or more of these more be more important than others. The activation delay logic 1400 evaluates context in block 1401, evaluates proximity factors in block 1402, evaluates probability factors in block 1403, and evaluates consequences in block 1404.

For example, evaluation of contextual factors 1402 can include implied context such as “being used in bed” or “being used in a reclining chair”. This context could be manually selected or automatically detected through techniques such as visual object recognition or location sensors (e.g. a tablet detects that it is connected to a bed mount). Factors 1401 include some of the many possible such factors.

Evaluation of proximity factors 1402 can include location detection services to determine that a specific target device like a television is nearby or that the user is in a specific room of their house which also includes an automatable door, light, or window shades. These location services could be based on visual object detection systems, wireless proximity detection sensors such as IR or RF beacons or other types of indoor location services and proximity maps. For example, a rule could exist such as “decrease television button activation gaze delay by 25% when within 5” or “increase television button activation delay by 300% when not in the same room”. Factors 1402 include some of the many possible such factors.

Evaluation of probability factors 1403 can include lookup databases of historical actions, such as “this person frequently flips through the channels of their television” or “this person frequently lowers the lights after turning on the television and lowering the shades”. This could include chronological associations such as “this person commonly opens the window shades after first entering the room around 8 am” or “this person generally turns on the television at 1:55 PM to watch Judge Judy”. Factors 1403 include some of the many possible such factors.

Evaluation of consequence factors 1404 can include considerations such as “opening the door” has higher potential negative outcomes (e.g. loss of HVAC temperature control or the imminent escape of their dog “Fluffy Bumpkins”). Factors 1304 include some of the many possible such factors.

Once the context, proximity, probability, and consequence factors are evaluated, the activation delay engine logic 1400 then in block 1405, for each user interface element associated with an action, combines these influencing factors in block 1406 and using this result, in block 1407, to modify/set a corresponding gaze activation delay for each of the user interface elements. The logic then returns (as for example, described in FIG. 9). As described with respect to FIG. 12, combining may involve summation, weighted combinations, as well as different mathematical functions.

As explained above, the EGDAS is operable in many different environments and the eye gaze activation delay timing can be computed accordingly.

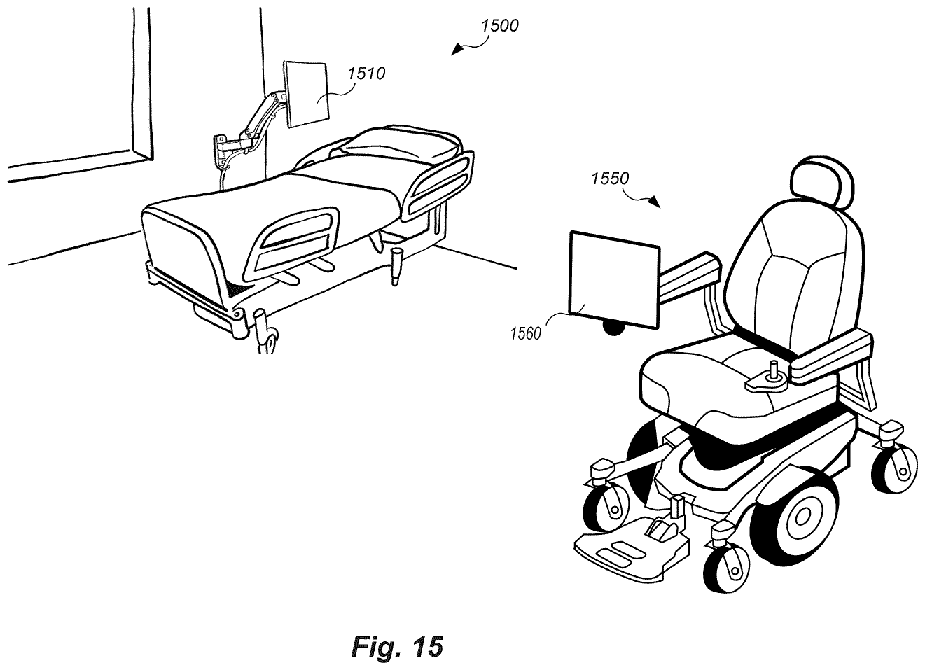

FIG. 15 illustrates example environments that include an eye gaze camera and display systems in powered beds and wheelchairs for practicing an example Eye Gaze Dwell Activation System. In the powered bed environment 1500, a display with attached eye gaze camera 1510 is mounted to a hospital bed for use by the bed occupant. In the powered wheelchair environment 1550, a display with attached eye gaze camera 1560 is mounted to a powered wheelchair for use by the wheelchair occupant. Both displays 1510 and 1560 contain the components of the example computing system for EGDAS detailed in FIG. 10.

FIG. 16 is an example environment that includes an eye gaze camera and display system in a headset used for virtual or augmented reality for practicing an example Eye Gaze Dwell Activation System. One example implementation is an Apple Vision Pro device 1600 (see e.g., https://www.apple.com/apple-vision-pro) which is an augmented reality headset which, from the inside view 1650, contains both cameras 1660 and IR emitters 1665 which are used to determine eye gaze vectors within the augmented reality display. Other example implementations include the Meta Quest Pro (see e.g., https://www.meta.com/quest/quest-pro/) augmented reality classes and similar devices.

FIG. 17 is an example block diagram of an augmented reality system for practicing an example Eye Gaze Dwell Activation System. Environment 1700 presents visual elements overlayed in a mixed reality view as perceived by the person using an augmented reality system. In environment 1700, the augmented reality glasses 1725 present a view of the ‘external world’ 1775 outside of the glasses intermixed with eye gaze interactable visual elements 1750 within an integrated field of view.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 63/611,912, titled “METHOD, SYSTEM, AND TECHNIQUES FOR VARYING EYE GAZE DWELL ACTIVATION,” filed Dec. 19, 2023; are incorporated herein by reference in their entireties

From the foregoing it will be appreciated that, although specific embodiments have been described herein for purposes of illustration, various modifications may be made without deviating from the spirit and scope of the invention. For example, the methods, systems, and techniques for determining and using variable dwell time discussed herein are applicable to other architectures and devices. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, glasses, headsets, Augmented Reality devices, etc.).

1. A method in a computing system for controlling eye gaze actuation boundaries in a variable fashion within a user interface comprising a plurality of user interface elements, comprising:
associating each of a plurality of the user interface elements with a different actuation boundary wherein each actuation boundary associated is based upon one or more characteristics and wherein at least two of the actuation boundaries are distinct;
receiving a stream of eye gaze data;
determining, from the received data and from the actuation boundaries associated with each of the plurality of user interface elements, which user interface element is to be actuated; and
causing actuation of the determined user interface element to be actuated.

2. The method of claim 1 wherein the one or more characteristics include one or more of probabilities, context, consequence and/or proximity.

3. The method of claim 1 wherein the one or more characteristics are probabilities of a user interface element to be actuated.

4. The method of claim 1 wherein the user interface implements a virtual keyboard, each user interface element is a key, and wherein frequency of character or symbol occurrences in a designated language is used to associate each key with an eye gaze actuation boundary.

5. The method of claim 1 wherein the user interface a virtual keyboard, each user interface element is a key, and wherein context of character, symbol, or language unit occurrences in a designated language are used to associate each key with an eye gaze actuation boundary.

6. The method of claim 1, further comprising:
receiving addition eye gaze data in the data stream;
before determining a next user interface element to be actuated, modifying the association of at least some of the plurality of the user interface elements with a different actuation boundary based upon the one or more characteristics; and
determining the next user interface element to be actuated based upon the modified actuation boundaries associated with the at least some of the plurality of user interface elements.

7. The method of claim 1, further comprising filtering or modifying the eye gaze data stream to remove noise or accidental gaze changes.

8. The method of claim 1 wherein the user interface implements an interface having one or more action user interface elements, and wherein a consequence associated with each of the one or more action user interface elements is used to associate each user interface element with an eye gaze actuation boundary.

9. The method of claim 8 wherein the user interface implements an electronic game or simulation.

10. The method of claim 8 wherein the user interface implements an interface to control a vehicle or a drone.

11. The method of claim 8 wherein a lower eye gaze actuation boundary is associated with a lower consequence action user interface element when an action corresponding to the user interface element has a lower consequence than a second other action.

12. The method of claim 11 wherein consequence of an action is based upon safety or danger.

13. The method of claim 12 wherein a higher eye gaze actuation boundary is associated with a higher consequence action user interface element when the action corresponding to the user interface element could result in a collision.

14. The method of claim 1 wherein the user interface implements an interface having one or more action user interface elements for controlling a plurality of automated devices, and wherein proximity of a controller device controlling the user interface to each of the plurality of automated devices is used to associate each user interface element with an eye gaze actuation boundary.

15. The method of claim 14 wherein the user interface implements a control device for home automation.

16. The method of claim 14 wherein a lower eye gaze actuation boundary is associated with a first user interface element than with a second user interface element when an automated device corresponding to the first user interface element is in greater proximity to the controller device controlling the user interface than an automated device corresponding to the second user interface element.

17. The method of claim 14 wherein a higher eye gaze actuation boundary is associated with a first user interface element than with a second user interface element when an automated device corresponding to the first user interface element is located further from the controller device controlling the user interface than an automated device corresponding to the second user interface element.

18. The method of claim 1 wherein the one or more characteristics includes one or more of probabilities, context, consequence and/or proximity and further comprises combining one or more of the one or more characteristics to associate each of the plurality of user interface elements with the different actuation boundary.

19. A computer readable storage medium comprising instructions for eye gaze actuation boundaries in a variable fashion within a user interface that, when executed on a computer processor, performs a method of:
associating each of a plurality of user interface elements of the user interface with a different actuation boundary wherein each actuation boundary associated is based upon one or more characteristics and wherein at least two of the actuation boundaries are distinct;
receiving a stream of eye gaze data;
determining, from the received data and from the actuation boundaries associated with each of the plurality of user interface elements, which user interface element is to be actuated; and
causing actuation of the determined user interface element to be actuated.

20. The computer-readable storage medium of claim 19 wherein the one or more characteristics include one or more of probabilities, context, consequences and/or proximity factors.

21. The computer-readable storage medium of claim 19 wherein the user interface implements an interface to control a vehicle or a drone, and the actuation boundary associated with each user interface element is determined based upon a consequence or probability of a possible collision.

22. The computer-readable storage medium of claim 19 wherein the user interface implements an interface to control a vehicle or a drone, and the actuation boundary associated with each user interface element is determined based upon safety factors.

23. The computer-readable storage medium of claim 19 wherein the user interface implements a virtual keyboard, each user interface element is a key, and wherein frequency of character or symbol occurrences in a designated language is used to associate each key with an eye gaze actuation boundary.

24. The computer-readable storage medium of claim 19 wherein the user interface implements a control device for home automation of a plurality of automated devices and proximity of a controller device controlling the user interface to an automated device is used to associate each user interface element with an eye gaze actuation boundary.

25. An eye gaze dwell activation system comprising:
a computer processor; and
a memory storing code logic that, when executed on the computer processor:
associates each of a plurality of user interface elements of a user interface with a different actuation boundary, wherein each actuation boundary associated is based upon one or more characteristics and wherein at least two of the actuation boundaries are distinct;
receives a stream of eye gaze data;
determines, from the received data and from the actuation boundaries associated with each of the plurality of user interface elements, which user interface element is to be actuated; and
causes actuation of the determined user interface element to be actuated.

26. The eye gaze dwell activation system of claim 25 wherein the one or more characteristics include one or more of probabilities, context, consequence and/or proximity.

27. The eye gaze dwell activation system of claim 25 wherein the user interface implements a virtual keyboard, each user interface element is a key, and wherein frequency of character or symbol occurrences in a designated language is used to associate each key with an eye gaze actuation boundary.

28. The eye gaze dwell activation system of claim 25 wherein the user interface implements an interface having one or more action user interface elements, and wherein a consequence associated with each of the one or more action user interface elements is used to associate each user interface element with an eye gaze actuation boundary.

29. The eye gaze dwell activation system of claim 25 wherein the user interface implements an interface to control a vehicle or a drone.

30. The eye gaze dwell activation system of claim 25 wherein the actuation boundary associated with each user interface element is determined based upon safety factors.
